(19) United States
(12) Patent Application Publication
(10) Pub. No.: US 2008/0225107 A1
(43) Pub. Date: Sep. 18, 2008

(54) Line Head, and an Image Forming Apparatus and an Image Forming Method Using the Line Head

(75) Inventors: Ryuta KOIZUMI, Shiojiri-shi (JP); Yujiro NOMURA, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/046,323

(22) Filed: Mar. 11, 2008

(30) Foreign Application Priority Data
Mar. 15, 2007 (JP) 2007-067413
Oct. 2, 2007 (JP) 2007-258913

(51) Int. Cl. B41J 2/45

(52) U.S. Cl. 347/238

(57) ABSTRACT

A line head, includes: a substrate on which a plurality of light emitting elements are provided; a lens array that includes a plurality of lenses; and a cover member that is optically transmissive, is opposed to the lens array, and is provided at the other side of the substrate with respect to the lens array.

### CROSS REFERENCE TO RELATED APPLICATION

The disclosure of Japanese Patent Applications No. 2007-067413 filed on Mar. 15, 2007 and No. 2007-258913 filed on Oct. 2, 2007 including specification, drawings and claims is incorporated herein by reference in its entirety.

### BACKGROUND

1. Technical Field

The invention relates to a technology for forming an image by exposing a latent image carrier surface such as a photosensitive member surface using a line head.

2. Related Art

There is known a technology for forming an electrostatic latent image by exposing a photosensitive member surface with light beams while conveying the photosensitive member surface in a sub scanning direction. Specifically, according to such a technology, a two-dimensional electrostatic latent image is formed on the photosensitive member surface by exposing the photosensitive member surface with light beams arrayed in a main scanning direction while conveying the photosensitive member surface in the sub scanning direction. JP-A-2-4546 discloses a line head for focusing light beams emitted from light emitting elements toward a photosensitive member surface and a technology for exposing the photosensitive member surface using the line head. More specifically, in such a line head, a plurality of light emitting element groups each including a plurality of light emitting elements are arranged in a longitudinal direction corresponding to the main scanning direction. A plurality of lenses are arranged in a one-to-one correspondence with these plurality of light emitting element groups. Each of the plurality of lenses focuses light beams emitted from the light emitting elements of the corresponding light emitting element group toward the photosensitive member surface. The photosensitive member surface is exposed with the light beams focused in this way.

In this way, the photosensitive member surface is exposed with the light beams and an electrostatic latent image is formed. In an image forming apparatus using such a line head, the electrostatic latent image is developed with toner to be visualized.

### SUMMARY

Incidentally, upon arranging lenses with respect to each light emitting element group, it may be constructed as follows. Specifically, the line head can be constructed by arranging a lens array including a plurality of lenses between the plurality of light emitting element groups and an image plane (photosensitive member surface).

However, in the case where the electrostatic latent image formed by exposing the image plane is developed by a developing unit with toner, there is a possibility of occurring a following problem due to toner (scattered-toner) scattered from the image plane. Specifically, since a plurality of lenses are arranged on the lens array, a surface of the lens array is not flat but in a substantially concavo-convex shape. Accordingly, the scattered-toner tends to accumulate on the surface. When the scattered-toner adheres to the surface of the lens array to accumulate thereon, a light quantity of the light beam transmissive through the lens array decreases, which leads to a decrease of a light quantity of the light beam contributing to the exposure of the image plane, and to a possibility of being unable to execute an excellent exposure.

An advantage of some aspects of the invention is to provide a technology for suppressing an occurrence of the problem that the scattered-toner adheres to the surface of the lens array to accumulate thereon and enabling an excellent exposure.

According to a first aspect of the invention, there is provided a line head, comprising: a substrate on which a plurality of light emitting elements are provided; a lens array that includes a plurality of lenses; and a cover member that is optically transmissive, is opposed to the lens array, and is provided at the other side of the substrate with respect to the lens array.

According to a second aspect of the invention, there is provided an image forming apparatus, comprising: a latent image carrier; a line head that exposes a surface of the latent image carrier with light beams to form a latent image; and a developing unit that develops the latent image with toner, wherein the line head includes: a substrate on which a plurality of light emitting elements are provided; a lens array that includes a plurality of lenses; and a cover member that is optically transmissive, is provided between the latent image carrier and the lens array, and is provided at the other side of the substrate with respect to the lens array.

According to a third aspect of the invention, there is provided an image forming method, comprising: exposing a latent image carrier surface with light beams using a line head to form a latent image; and developing the latent image with toner, wherein the line head includes: a substrate on which a plurality of light emitting elements are provided; a lens array that includes a plurality of lenses; and a cover member that is optically transmissive, is provided between the latent image carrier and the lens array, and is provided at the other side of the substrate with respect to the lens array.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing an embodiment of an image forming apparatus according to the invention.

FIG. 2 is a diagram showing the electrical construction of the image forming apparatus of FIG. 1.

FIG. 3 is a perspective view schematically showing one embodiment of a line head according to the invention.

FIG. 4 is a sectional view along a width direction showing the embodiment of the line head according to the invention.

FIG. 5 is a schematic partial perspective view of the lens array.

FIG. 6 is a sectional view of the lens array in the longitudinal direction LGD.

FIG. 7 is a diagram showing the arrangement of the light emitting element groups in the line head.

FIG. 8 is a diagram showing the arrangement of the light emitting elements in each light emitting element group.

FIG. 9 is a diagram showing a focusing state of the lens in a section including the longitudinal direction and the optical axis.

FIG. 10 is a diagram showing a focusing state of the lens in a section including the width direction and the optical axis.

FIGS. 11 and 12 are diagrams showing terminology used in this specification.

FIG. 13 is a diagram showing the lens position and the like.

FIG. 14 is a diagram showing a spot forming operation by the above-described line head.

FIG. 15 is a sectional view along the sub scanning direction showing the relationship of arrangement of the line head and the photosensitive drum.

FIG. 16 is a sectional view along the sub scanning direction showing the relationship of arrangement of the lens array the line head includes and the photosensitive drum.

FIG. 17 shows the lens data of the lens LS used in the simulation of the comparative example 1.

FIG. 18 shows aspherical surface coefficients of the aspherical surfaces S4, S5.

FIG. 19 shows the specification of an optical system used in the simulation of the comparative example 1.

FIG. 20 shows a simulation result in the case where all the lenses LS1 to LS3 are formed based on the data given by above FIG. 17 to FIG. 19 and the equation (1).

FIG. 21 is a sectional view along the sub scanning direction showing the relationship of arrangement of a line head and a photosensitive drum according to a working example 1 of the invention.

FIG. 22 is a perspective view of the line head in the working example 1.

FIG. 23 shows the lens data of the lens LS2.

FIG. 24 shows the aspherical surface coefficient of the lens LS2.

FIG. 25 shows the lens data of the lenses LS1, LS3.

FIG. 26 shows the aspherical surface coefficients of the lenses LS1, LS3.

FIG. 27 is a diagram describing surface numbers and surfaces corresponding thereto in the working example 1.

FIG. 28 shows the specification of an optical system used in a simulation of the working example 1.

FIG. 29 shows a simulation result executed based on the data given by above FIG. 23 to FIG. 28.

FIG. 30 is a sectional view along the sub scanning direction showing the relationship of arrangement of the line head and the photosensitive drum in the comparative example 2.

FIG. 31 is a sectional view along the sub scanning direction showing the relationship of arrangement of the lens array the line head includes and the photosensitive drum.

FIG. 32 shows a simulation result in the case where all the lenses LS1 to LS4 are formed based on the data given by above FIG. 17 to FIG. 19 and the equation (1).

FIG. 33 is a sectional view along the sub scanning direction showing the relationship of arrangement of a line head and a photosensitive drum according to a working example 2 of the invention.

FIG. 34 shows the lens data of the lenses LS2, LS3.

FIG. 35 shows the aspherical surface coefficient of the lenses LS2, LS3.

FIG. 36 shows the lens data of the lenses LS1, LS4.

FIG. 37 shows the aspherical surface coefficients of the lenses LS1, LS4.

FIG. 38 shows the specification of an optical system used in a simulation of the working example 2.

FIG. 39 shows a simulation result executed based on the data given by above FIG. 34 to FIG. 38.

FIG. 40 is a partial sectional view along the width direction showing a construction of a line head in a working example 3.

FIG. 41 is a diagram showing a construction of an optical system of the line head in the working example 3.

FIG. 42 is a diagram describing surface numbers and surfaces corresponding thereto.

FIG. 43 shows the lens data of the lenses LSa2, LSb2.

FIG. 44 shows the aspherical surface coefficient of the lenses LSa2, LSb2.

FIG. 45 shows the lens data of the lenses LSa1, LSb1, LSa3, LSb3.

FIG. 46 shows the aspherical surface coefficients of the lenses LSa1, LSb1, LSa3, LSb3.

FIG. 47 shows the specification of an optical system used in a simulation of the working example 3.

FIG. 48 shows a simulation result executed based on the data given by above FIG. 43 to FIG. 47.

FIGS. 49A and 49B are graphs showing the example of the method for calculating the focus position.

FIG. 50 is a diagram showing other shape of the opposed surface of the clear substrate.

FIG. 51 is a sectional view along the sub scanning direction showing an effect in the case where an image side of a lens is constructed to be telecentric.

FIG. 52 is a sectional view along the sub scanning direction showing an image forming apparatus including the line head according to the invention.

FIG. 53 is a perspective view of a cleaner.

FIG. 54 is a diagram showing a cleaning operation performed by the cleaner.

FIG. 55 is a cross sectional view showing a location of the cleaner during the latent image forming operation.

### DESCRIPTION OF EXEMPLARY EMBODIMENTS

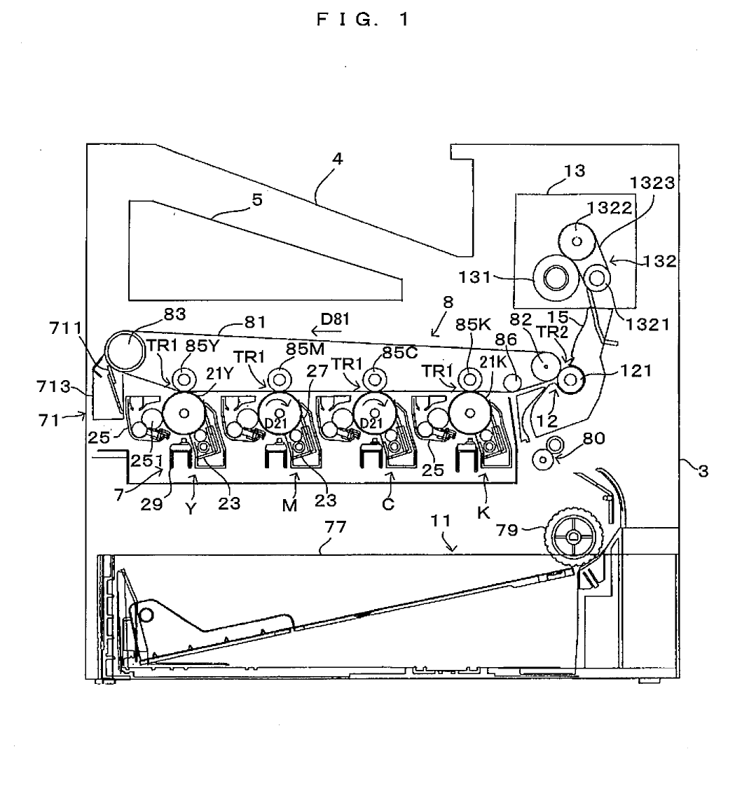

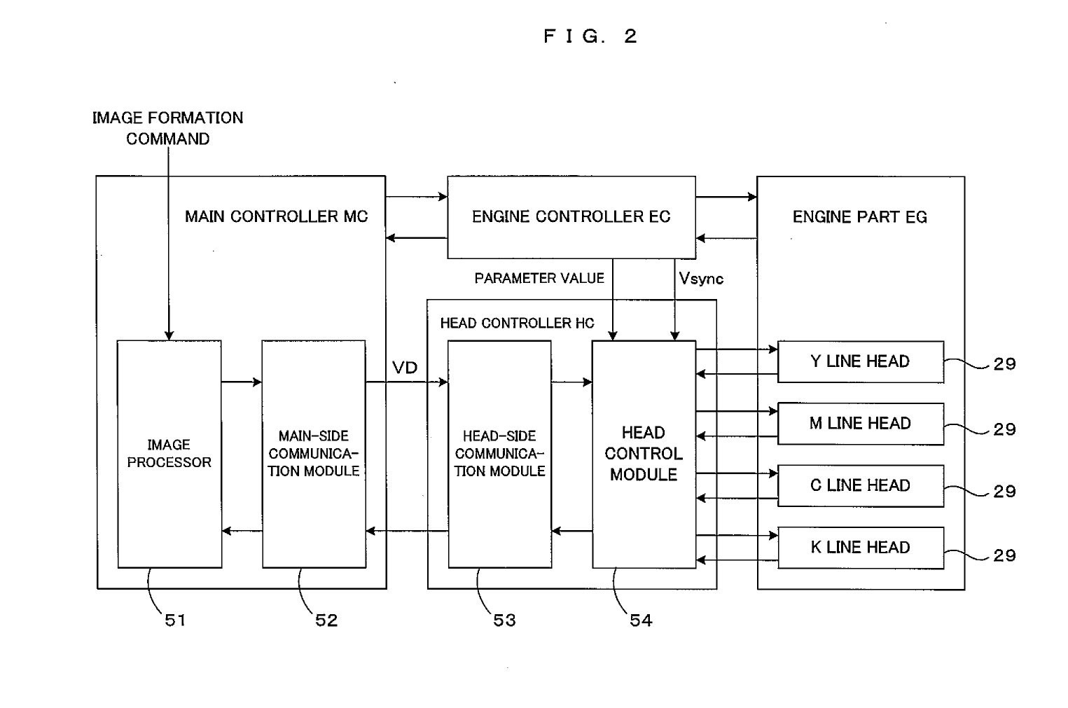

FIG. 1 is a diagram showing an embodiment of an image forming apparatus according to the invention, and FIG. 2 is a diagram showing the electrical construction of the image forming apparatus of FIG. 1. This apparatus is an image forming apparatus that can selectively execute a color mode for forming a color image by superimposing four color toners of black (K), cyan (C), magenta (M) and yellow (Y) and a monochromatic mode for forming a monochromatic image using only black (K) toner. FIG. 1 is a diagram corresponding to the execution of the color mode. In this image forming apparatus, when an image formation command is given from an external apparatus such as a host computer to a main controller MC having a CPU and memories, the main controller MC feeds a control signal and the like to an engine controller EC and feeds video data VD corresponding to the image formation command to a head controller HC. This head controller HC controls line heads 29 of the respective colors based on the video data VD from the main controller MC, a vertical synchronization signal Vsync from the engine controller EC and parameter values from the engine controller EC. In this way, an engine part EG performs a specified image forming operation to form an image corresponding to the image formation command on a sheet such as a copy sheet, transfer sheet, form sheet or transparent sheet for OHP.

An electrical component box 5 having a power supply circuit board, the main controller MC, the engine controller EC and the head controller HC built therein is disposed in a housing main body 3 of the image forming apparatus according to this embodiment. An image forming unit 7, a transfer belt unit 8 and a sheet feeding unit 11 are also arranged in the housing main body 3. A secondary transfer unit 12, a fixing unit 13, and a sheet guiding member 15 are arranged at the right side in the housing main body 3 in FIG. 1. It should be noted that the sheet feeding unit 11 is detachably mountable into the housing main body 3. The sheet feeding unit 11 and the transfer belt unit 8 are so constructed as to be detachable for repair or exchange respectively.

The image forming unit 7 includes four image forming stations Y (for yellow), M (for magenta), C (for cyan) and K (for black) which form a plurality of images having different colors. Each of the image forming stations Y, M, C and K includes a cylindrical photosensitive drum 21 having a surface of a specified length in a main scanning direction MD. It is to be noted that a shape of a curved surface of a cylindrical form is defined as a “curvature shape”, and “a surface has a curvature” means that the shape of the surface is a curvature shape in this specification. Further, when it is called that “a curvature center of a curvature shape”, the curvature center means a point on the central axis of the cylindrical form. Each of the image forming stations Y, M, C and K forms a toner image of the corresponding color on the surface of the photosensitive drum 21. The photosensitive drum is arranged so that the axial direction thereof is substantially parallel to the main scanning direction MD. Each photosensitive drum 21 is connected to its own driving motor and is driven to rotate at a specified speed in a direction of arrow D21 in FIG. 1, whereby the surface of the photosensitive drum 21 is transported in a sub scanning direction SD which is orthogonal or substantially orthogonal to the main scanning direction MD. Further, a charger 23, the line head 29, a developer 25 and a photosensitive drum cleaner 27 are arranged in a rotating direction around each photosensitive drum 21. A charging operation, a latent image forming operation and a toner developing operation are performed by these functional sections. Accordingly, a color image is formed by superimposing toner images formed by all the image forming stations Y, M, C and K on a transfer belt 81 of the transfer belt unit 8 at the time of executing the color mode, and a monochromatic image is formed using only a toner image formed by the image forming station K at the time of executing the monochromatic mode. Meanwhile, since the respective image forming stations of the image forming unit 7 are identically constructed, reference characters are given to only some of the image forming stations while being not given to the other image forming stations in order to facilitate the diagrammatic representation in FIG. 1.

The charger 23 includes a charging roller having the surface thereof made of an elastic rubber. This charging roller is constructed to be rotated by being held in contact with the surface of the photosensitive drum 21 at a charging position. As the photosensitive drum 21 rotates, the charging roller is rotated at the same circumferential speed in a direction driven by the photosensitive drum 21. This charging roller is connected to a charging bias generator (not shown) and charges the surface of the photosensitive drum 21 at the charging position where the charger 23 and the photosensitive drum 21 are in contact upon receiving the supply of a charging bias from the charging bias generator.

The line head 29 is arranged relative to the photosensitive drum 21 so that the longitudinal direction thereof corresponds to the main scanning direction MD and the width direction thereof corresponds to the sub scanning direction SD. Hence, the longitudinal direction of the line head 29 is substantially parallel to the main scanning direction MD. The line head includes a plurality of light emitting elements arrayed in the longitudinal direction and is positioned separated from the photosensitive drum 21. Light beams are emitted from these light emitting elements to irradiate (in other words, expose) the surface of the photosensitive drum 21 charged by the charger 23, thereby forming a latent image on this surface (exposing step). In this embodiment, the head controller HC is provided to control the line heads 29 of the respective colors, and controls the respective line heads 29 based on the video data VD from the main controller MC and a signal from the engine controller EC. Specifically, in this embodiment, image data included in an image formation command is inputted to an image processor 51 of the main controller MC. Then, video data VD of the respective colors are generated by applying various image processings to the image data, and the video data VD are fed to the head controller HC via a main-side communication module 52. In the head controller HC, the video data VD are fed to a head control module 54 via a head-side communication module 53. Signals representing parameter values relating to the formation of a latent image and the vertical synchronization signal Vsync are fed to this head control module 54 from the engine controller EC as described above. Based on these signals, the video data VD and the like, the head controller HC generates signals for controlling the driving of the elements of the line heads 29 of the respective colors and outputs them to the respective line heads 29. In this way, the operations of the light emitting elements in the respective line heads 29 are suitably controlled to form latent images corresponding to the image formation command.

In this embodiment, the photosensitive drum 21, the charger 23, the developer 25 and the photosensitive drum cleaner 27 of each of the image forming stations Y, M, C and K are unitized as a photosensitive cartridge. Further, each photosensitive cartridge includes a nonvolatile memory for storing information on the photosensitive cartridge. Wireless communication is performed between the engine controller EC and the respective photosensitive cartridges. By doing so, the information on the respective photosensitive cartridges is transmitted to the engine controller EC and information in the respective memories can be updated and stored.

The developer (developing unit) 25 includes a developing roller 251 carrying toner on the surface thereof. By a development bias applied to the developing roller 251 from a development bias generator (not shown) electrically connected to the developing roller 251, charged toner is transferred from the developing roller 251 to the photosensitive drum 21 to develop the latent image formed by the line head 29 at a development position where the developing roller 251 and the photosensitive drum 21 are in contact (developing step).

The toner image developed at the development position in this way is primarily transferred to the transfer belt 81 at a primary transfer position TR1 to be described later where the transfer belt 81 and each photosensitive drum 21 are in contact after being transported in the rotating direction D21 of the photosensitive drum 21.

Further, in this embodiment, the photosensitive drum cleaner 27 is disposed in contact with the surface of the photosensitive drum 21 downstream of the primary transfer position TR1 and upstream of the charger 23 with respect to the rotating direction D21 of the photosensitive drum 21. This photosensitive drum cleaner 27 removes the toner remaining on the surface of the photosensitive drum 21 to clean after the primary transfer by being held in contact with the surface of the photosensitive drum.

The transfer belt unit 8 includes a driving roller 82, a driven roller (blade facing roller) 83 arranged to the left of the driving roller 82 in FIG. 1, and the transfer belt 81 mounted on these rollers and driven to turn in a direction of arrow D81 in FIG. 1 (conveying direction). The transfer belt unit 8 also includes four primary transfer rollers 85Y, 85M, 85C and 85K arranged to face in a one-to-one relationship with the photosensitive drums 21 of the respective image forming stations Y, M, C and K inside the transfer belt 81 when the photosensitive cartridges are mounted. These primary transfer rollers 85Y, 85M, 85C and 85K are respectively electrically connected to a primary transfer bias generator not shown. As described in detail later, at the time of executing the color mode, all the primary transfer rollers 85Y, 85M, 85C and 85K are positioned on the sides of the image forming stations Y, M, C and K as shown in FIG. 1, whereby the transfer belt 81 is pressed into contact with the photosensitive drums 21 of the image forming stations Y, M, C and K to form the primary transfer positions TR1 between the respective photosensitive drums 21 and the transfer belt 81. By applying primary transfer biases from the primary transfer bias generator to the primary transfer rollers 85Y, 85M, 85C and 85K at suitable timings, the toner images formed on the surfaces of the respective photosensitive drums 21 are transferred to the surface of the transfer belt 81 at the corresponding primary transfer positions TR1 to form a color image.

On the other hand, out of the four primary transfer rollers 85Y, 85M, 85C and 85K, the color primary transfer rollers 85Y, 85M, 85C are separated from the facing image forming stations Y, M and C and only the monochromatic primary transfer roller 85K is brought into contact with the image forming station K at the time of executing the monochromatic mode, whereby only the monochromatic image forming station K is brought into contact with the transfer belt 81. As a result, the primary transfer position TR1 is formed only between the monochromatic primary transfer roller 85K and the image forming station K. By applying a primary transfer bias at a suitable timing from the primary transfer bias generator to the monochromatic primary transfer roller 85K, the toner image formed on the surface of the photosensitive drum 21 is transferred to the surface of the transfer belt 81 at the primary transfer position TR1 to form a monochromatic image.

The transfer belt unit 8 further includes a downstream guide roller 86 disposed downstream of the monochromatic primary transfer roller 85K and upstream of the driving roller 82. This downstream guide roller 86 is so disposed as to come into contact with the transfer belt 81 on an internal common tangent to the primary transfer roller 85K and the photosensitive drum 21 at the primary transfer position TR1 formed by the contact of the monochromatic primary transfer roller 85K with the photosensitive drum 21 of the image forming station K.

The driving roller 82 drives to rotate the transfer belt 81 in the direction of the arrow D81 and doubles as a backup roller for a secondary transfer roller 121. A rubber layer having a thickness of about 3 mm and a volume resistivity of 1000 kΩ·cm or lower is formed on the circumferential surface of the driving roller 82 and is grounded via a metal shaft, thereby serving as an electrical conductive path for a secondary transfer bias to be supplied from an unillustrated secondary transfer bias generator via the secondary transfer roller 121. By providing the driving roller 82 with the rubber layer having high friction and shock absorption, an impact caused upon the entrance of a sheet into a contact part (secondary transfer position TR2) of the driving roller 82 and the secondary transfer roller 121 is unlikely to be transmitted to the transfer belt 81 and image deterioration can be prevented.

The sheet feeding unit 11 includes a sheet feeding section which has a sheet cassette 77 capable of holding a stack of sheets, and a pickup roller 79 which feeds the sheets one by one from the sheet cassette 77. The sheet fed from the sheet feeding section by the pickup roller 79 is fed to the secondary transfer position TR2 along the sheet guiding member 15 after having a sheet feed timing adjusted by a pair of registration rollers 80.

The secondary transfer roller 121 is provided freely to abut on and move away from the transfer belt 81, and is driven to abut on and move away from the transfer belt 81 by a secondary transfer roller driving mechanism (not shown). The fixing unit 13 includes a heating roller 131 which is freely rotatable and has a heating element such as a halogen heater built therein, and a pressing section 132 which presses this heating roller 131. The sheet having an image secondarily transferred to the front side thereof is guided by the sheet guiding member 15 to a nip portion formed between the heating roller 131 and a pressure belt 1323 of the pressing section 132, and the image is thermally fixed at a specified temperature in this nip portion. The pressing section 132 includes two rollers 1321 and 1322 and the pressure belt 1323 mounted on these rollers. Out of the surface of the pressure belt 1323, a part stretched by the two rollers 1321 and 1322 is pressed against the circumferential surface of the heating roller 131, thereby forming a sufficiently wide nip portion between the heating roller 131 and the pressure belt 1323. The sheet having been subjected to the image fixing operation in this way is transported to the discharge tray 4 provided on the upper surface of the housing main body 3.

Further, a cleaner 71 is disposed facing the blade facing roller 83 in this apparatus. The cleaner 71 includes a cleaner blade 711 and a waste toner box 713. The cleaner blade 711 removes foreign matters such as toner remaining on the transfer belt after the secondary transfer and paper powder by holding the leading end thereof in contact with the blade facing roller 83 via the transfer belt 81. Foreign matters thus removed are collected into the waste toner box 713. Further, the cleaner blade 711 and the waste toner box 713 are constructed integral to the blade facing roller 83. Accordingly, if the blade facing roller 83 moves as described next, the cleaner blade 711 and the waste toner box 713 move together with the blade facing roller 83.

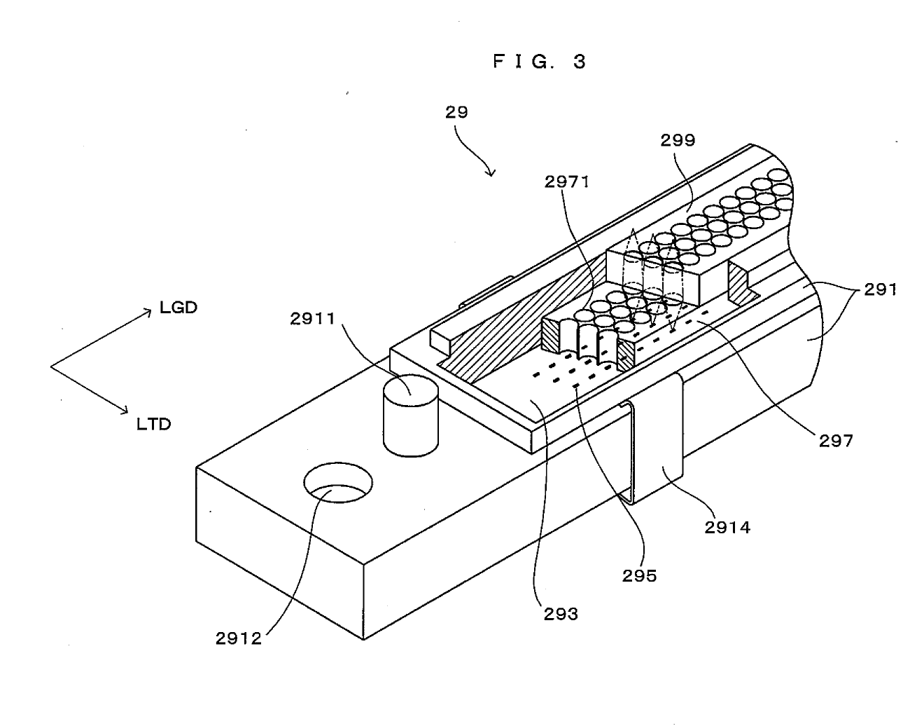

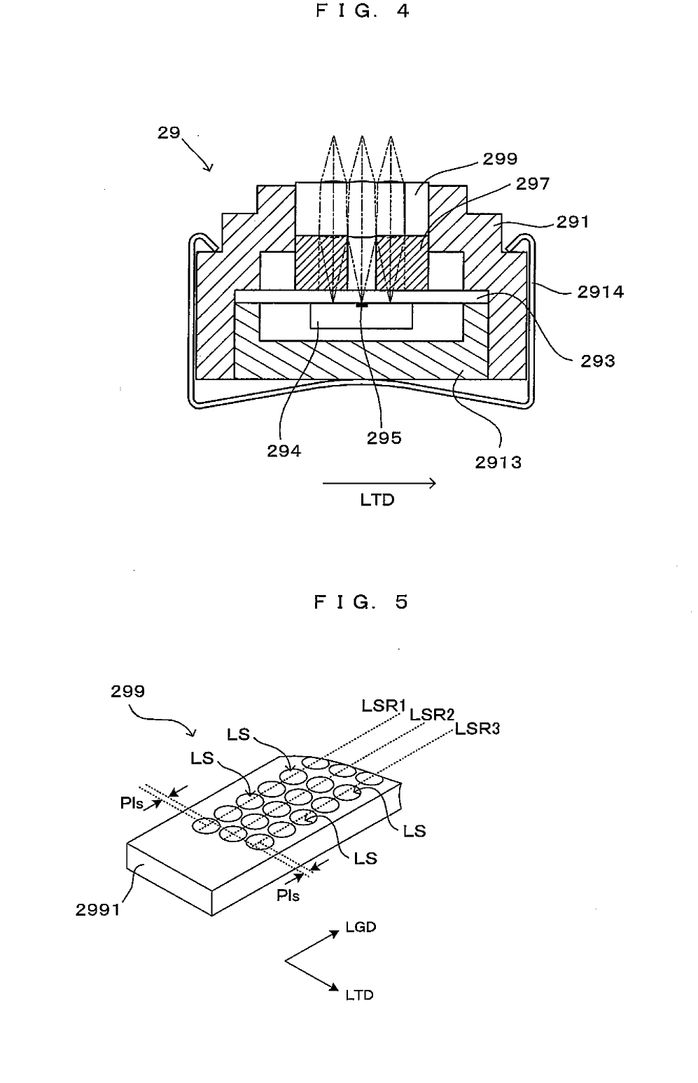

FIG. 3 is a perspective view schematically showing one embodiment of a line head according to the invention, and FIG. 4 is a sectional view along a width direction showing the embodiment of the line head according to the invention. As described above, the line head 29 is arranged to face the photosensitive drum 21 such that the longitudinal direction LGD corresponds to the main scanning direction MD and the width direction LTD corresponds to the sub scanning direction SD. The longitudinal direction LGD and the width direction LTD are substantially normal to each other. The line head 29 of this embodiment includes a case 291, and a positioning pin 2911 and a screw insertion hole 2912 are provided at each of the opposite ends of such a case 291 in the longitudinal direction LGD. The line head 29 is positioned relative to the photosensitive drum 21 by fitting such positioning pins 2911 into positioning holes (not shown) perforated in a photosensitive drum cover (not shown) covering the photosensitive drum 21 and positioned relative to the photosensitive drum 21. Further, the line head 29 is positioned and fixed relative to the photosensitive drum 21 by screwing fixing screws into screw holes (not shown) of the photosensitive drum cover via the screw insertion holes 2912 to be fixed.

The case 291 carries a lens array 299 at a position facing the surface of the photosensitive drum 21, and includes a light shielding member 297 and a head substrate 293 inside, the light shielding member 297 being closer to the lens array 299 than the head substrate 293. Further; a plurality of light emitting element groups 295 are provided on an under surface of the head substrate 293 (surface opposite to the lens array 299 out of two surfaces of the head substrate 293). Specifically, the plurality of light emitting element groups 295 are two-dimensionally arranged on the under surface of the head substrate 293 while being spaced by specified distances in the longitudinal direction LGD and the width direction LTD. Here, each light emitting element group 295 is formed by two-dimensionally arraying a plurality of light emitting elements. This is described in detail later. In this embodiment, bottom emission-type EL (electro-luminescence) devices are used as the light emitting elements. In other words, the organic EL devices are arranged as light emitting elements on the under surface of the head substrate 293 in this embodiment. Thus, all the light emitting elements 2951 are arranged on the same plane (under surface of the head substrate 293). When the respective light emitting elements are driven by a drive circuit formed on the head substrate 293, light beams are emitted from the light emitting elements in directions toward the photosensitive drum 21. These light beams propagate toward the light shielding member 297 via the head substrate 293.

The light shielding member 297 is perforated with a plurality of light guide holes 2971 in a one-to-one correspondence with the plurality of light emitting element groups 295. Such light guide holes 2971 are substantially cylindrical holes each penetrating the light shielding member 297 and having a center axis parallel to a normal to the head substrate 293. Thus, all the lights emitted from the light emitting elements belonging to one light emitting element group 295 propagate toward the lens array 299 via the same light guide hole 2971, and the interference of the light beams emitted from different light emitting element groups 295 is prevented by the light shielding member 297. The light beams having passed through the light guide holes 2971 perforated in the light shielding member 297 are focused as spots on the surface of the photosensitive drum 21 by the lens array 299. The specific structure of the lens array 299 and focused states of the light beams by the lens array 299 are described in detail later.

As shown in FIG. 4, an underside lid 2913 is pressed against the case 291 via the head substrate 293 by retainers 2914. Specifically, the retainers 2914 have elastic forces to press the underside lid 2913 toward the case 291, and seal the inside of the case 291 light-tight (that is, so that light does not leak from the inside of the case 291 and so that light does not intrude into the case 291 from the outside) by pressing the underside lid by means of the elastic force. It should be noted that a plurality of the retainers 2914 are provided at a plurality of positions in the longitudinal direction of the case 291. The light emitting element groups 295 are covered with a sealing member 294.

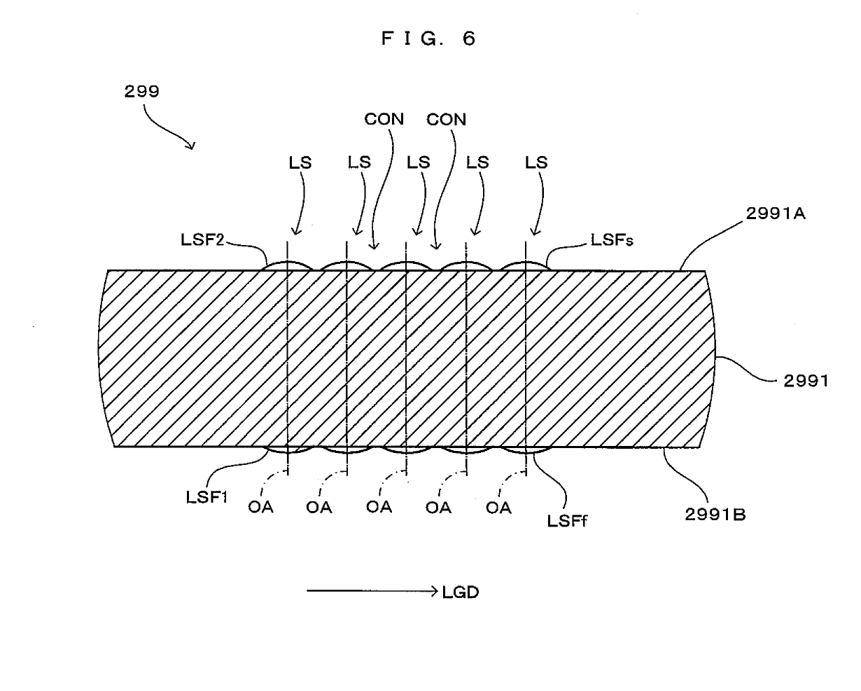

FIG. 5 is a schematic partial perspective view of the lens array, and FIG. 6 is a sectional view of the lens array in the longitudinal direction LGD. The lens array 299 includes a lens substrate 2991. First surfaces LSFf of lenses LS are formed on an under surface 2991B of the lens substrate 2991, and second surfaces LSFs of the lenses LS are formed on a top surface 2991A of the lens substrate 2991. The first and second surfaces LSFf, LSFs facing each other and the lens substrate 2991 held between these two surfaces function as one lens LS. The first and second surfaces LSFf, LSFs of the lenses LS can be made of resin for instance.

The lens array 299 is arranged such that optical axes OA of the plurality of lenses LS are substantially parallel to each other. The lens array 299 is also arranged such that the optical axes OA of the lenses LS are substantially normal to the under surface (surface where the light emitting elements 2951 are arranged) of the head substrate 293. At this time, these plurality of lenses LS are arranged in a one-to-one correspondence with the plurality of light emitting element groups 295. Specifically, the plurality of lenses LS are two-dimensionally arranged while being spaced apart at specified pitches in the longitudinal direction LGD and the width direction LTD in conformity with the arrangement of the light emitting element groups 295. More specifically, a plurality of lens rows LSR, in each of which a plurality of lenses LS are aligned in the longitudinal direction LGD, are arranged in the width direction LTD. In this embodiment, three lens rows LSR1, LSR2 and LSR3 are arranged in the width direction LTD. The three lens rows LSR1 to LSR3 are displaced from each other by a specified lens pitch Pls in the longitudinal direction.

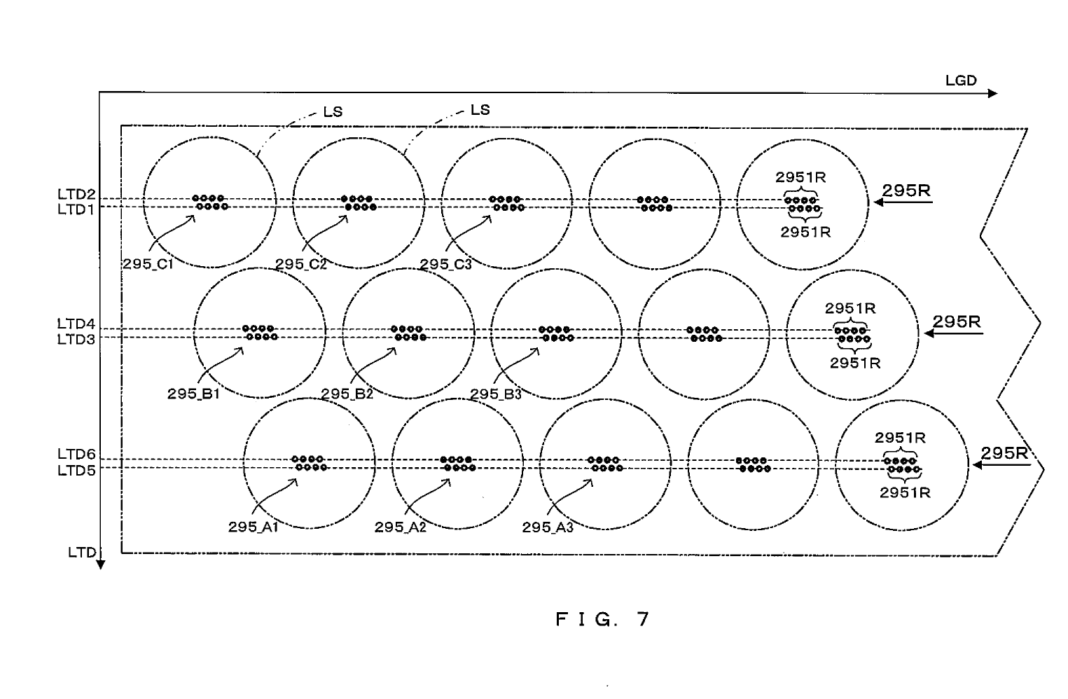

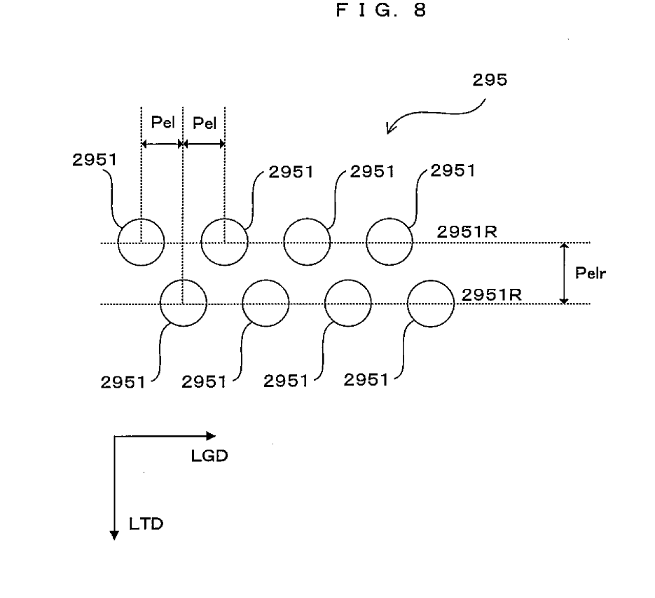

FIG. 7 is a diagram showing the arrangement of the light emitting element groups in the line head, and FIG. 8 is a diagram showing the arrangement of the light emitting elements in each light emitting element group. In this embodiment, eight light emitting elements 2951 are aligned at specified element pitches Pel in the longitudinal direction LGD in each light emitting element group 295. In each light emitting element group 295 of this embodiment, two light emitting element rows 2951R each formed by aligning four light emitting elements 2951 at specified pitches (twice the element pitch Pel) in the longitudinal direction LGD are arranged while being spaced apart by an element row pitch Pelr in the width direction LTD. The plurality of light emitting element groups 295 are arranged as follows.

Specifically, the plurality of light emitting element groups 295 are arranged such that three light emitting element group rows 295R each formed by aligning a specified number of light emitting element groups 295 in the longitudinal direction LGD are arranged in the width direction LTD. All the light emitting element groups 295 are arranged at mutually different longitudinal-direction positions. Further, the plurality of light emitting element groups 295 are arranged such that the light emitting element groups adjacent in the longitudinal direction (light emitting element groups 295_C1 and 295_B1 for example) differ in their width-direction positions. In this specification, it is defined that the position of each light emitting element is the geometric center of gravity thereof and that the position of the light emitting element group 295 is the geometric center of gravity of the positions of all the light emitting elements belonging to the same light emitting element group 295. The longitudinal-direction position and the width-direction position mean a longitudinal-direction component and a width-direction component of a particular position, respectively.

The light guide holes 2971 are perforated in the light shielding member 297 and the lenses LS are arranged in conformity with the arrangement of the above light emitting element groups 295. In other words, in this embodiment, the center of gravity positions of the light emitting element groups 295, the center axes of the light guide holes 2971 and the optical axes OA of the lenses LS substantially coincide. Light beams emitted from the light emitting elements 2951 of the light emitting element groups 295 are incident on the lens array 299 via the corresponding light guide holes 2971 and focused as spots on the surface of the photosensitive drum 21 by the lens array 299.

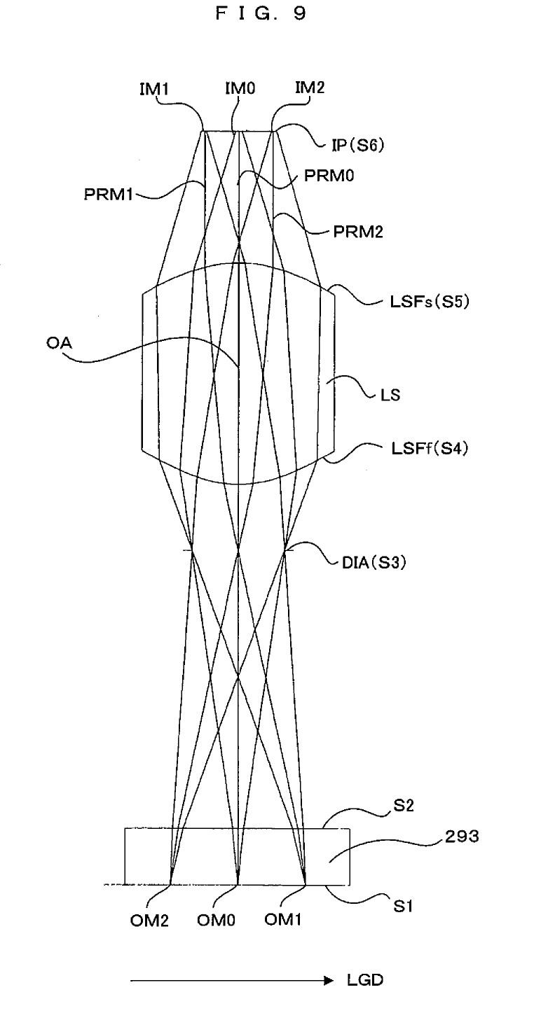

FIG. 9 is a diagram showing a focusing state of the lens in a section including the longitudinal direction and the optical axis. FIG. 9 shows trajectories of light beams from virtual object points OM0, OM1 and OM2 located on the under surface of the head substrate 293 in order to represent the focusing state of the lens LS. Here, the virtual object point OM0 is located on the optical axis OA, and the virtual object points OM1 and OM2 are located at positions symmetric with respect to the optical axis OA. As shown by such trajectories, the light beams emitted from the virtual object points emerge from the top surface of the head substrate 293 after being incident on the under surface of the head substrate 293. The light beams emerging from the top surface of the head substrate 293 reach an image plane IP (surface of the photosensitive drum 21) via the lens LS. Here, the head substrate 293 and the lens LS respectively have specified refractive indices.

As shown in FIG. 9, the light beam emitted from the virtual object point OM0 is focused on an intersection IM0 of the image plane IP and the optical axis OA. The light beams emitted from the virtual object points OM1, OM2 are focused on positions IM1, IM2 of the image plane. Specifically, the light beam emitted from the virtual object point OM1 is focused on the position IM1 at an opposite side with respect to the optical axis OA in the longitudinal direction LGD, and the light beam emitted from the virtual object point OM2 is focused on the position IM2 at an opposite side with respect to the optical axis OA in the longitudinal direction LGD. Thus, the lens LS in this embodiment is a so-called inverting optical system having an inverting property. As shown in FIG. 9, a distance between the positions IM1 and IM0 where the light beams are focused is shorter than a distance between the virtual object points OM1 and OM0. In other words, the absolute value of the magnification of an optical system comprised of the head substrate 293 and the lens LS in this embodiment is below 1. Further, an aperture diaphragm DIA is arranged at a front focus between the head substrate 293 and the first surface LSFf of the lens LS (that is, in an object space). As a result, chief rays PRM0 to PRM2 of the light beams are all parallel to the optical axis OA in an image space. In other words, an image side of the lens LS is telecentrically constructed.

FIG. 10 is a diagram showing a focusing state of the lens in a section including the width direction and the optical axis. FIG. 10 shows trajectories of light beams from virtual object points OS0, OS1 and OS2 located on the under surface of the head substrate 293 in order to represent the focusing state of the lens LS. Here, the virtual object point OS0 is located on the optical axis OA, and the virtual object points OS1 and OS2 are located at positions symmetric with respect to the optical axis OA. As shown by such trajectories, the light beams emitted from the virtual object points emerge from the top surface of the head substrate 293 after being incident on the under surface of the head substrate 293. The light beams emerging from the top surface of the head substrate 293 reach the image plane IP (surface of the photosensitive drum 21) via the lens LS. As described above, the head substrate 293 and the lens LS respectively have specified refractive indices.

As shown in FIG. 10, the light beam emitted from the virtual object point OS0 is focused on an intersection IS0 of the image plane IP and the optical axis OA. The light beams emitted from the virtual object points OS1, OS2 are focused on positions IS1, IS2 of the image plane. Specifically, the light beam emitted from the virtual object point OS1 is focused on the position IS1 at an opposite side with respect to the optical axis OA in the width direction LTD, and the light beam emitted from the virtual object point OS2 is focused on the position IS2 at an opposite side with respect to the optical axis OA in the width direction LTD. Thus, the lens LS in this embodiment is a so-called inverting optical system having an inverting property. As shown in FIG. 10, a distance between the positions IS1 and IS0 where the light beams are focused is shorter than a distance between the virtual object points OS1 and OS0. In other words, the absolute value of the magnification of the optical system comprised of the head substrate 293 and the lens LS in this embodiment is below 1. Further, the aperture diaphragm DIA is arranged at the front focus between the head substrate 293 and the first surface LSFf of the lens LS (that is, in the object space). As a result, chief rays PRS0 to PRS2 of the light beams are all parallel to the optical axis OA in the image space. In other words, the image side of the lens LS is telecentrically constructed.

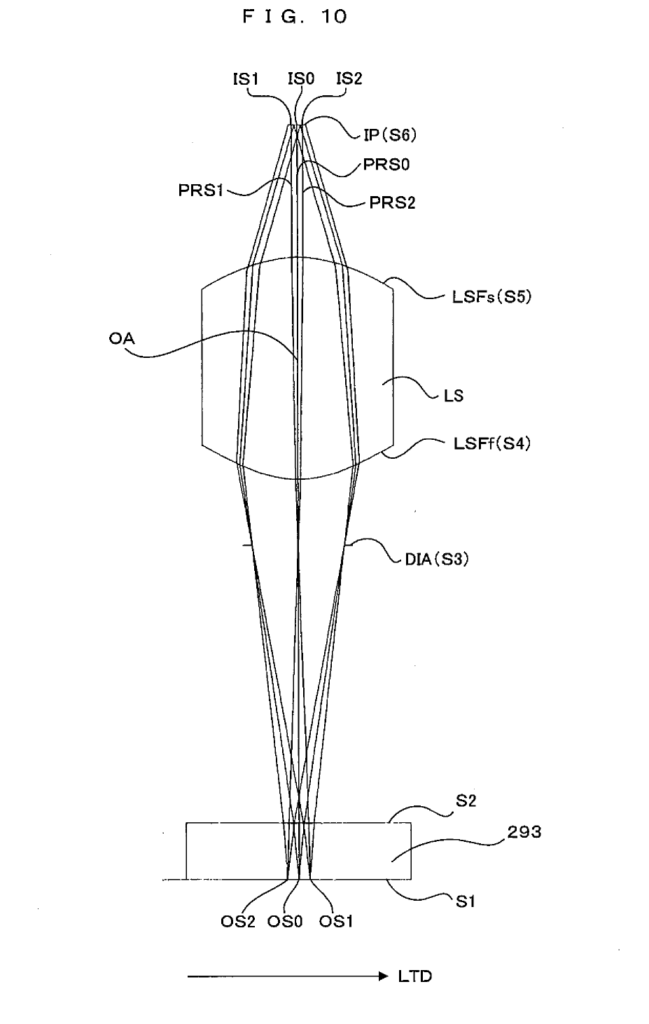

FIGS. 11 and 12 are diagrams showing terminology used in this specification. Here, terminology used in this specification is organized with reference to FIGS. 11 and 12. In this specification, as described above, a conveying direction of the surface (image plane IP) of the photosensitive drum 21 is defined to be the sub scanning direction SD and a direction substantially normal to the sub scanning direction SD is defined to be the main scanning direction MD. Further, a line head 29 is arranged relative to the surface (image plane IP) of the photosensitive drum 21 such that its longitudinal direction LGD corresponds to the main scanning direction MD and its width direction LTD corresponds to the sub scanning direction SD.

Collections of a plurality of (eight in FIGS. 11 and 12) light emitting elements 2951 arranged on the head substrate 293 in one-to-one correspondence with the plurality of lenses LS of the lens array 299 are defined to be light emitting element groups 295. In other words, in the head substrate 293, the plurality of light emitting element groups 295 are arranged in conformity with the plurality of lenses LS. And, each of the plurality of light emitting element groups 295 includes a plurality of light emitting elements 2951. Further, collections of a plurality of spots SP formed on the image plane IP by focusing light beams from the light emitting element groups 295 toward the image plane IP by the lenses LS corresponding to the light emitting element groups 295 are defined to be spot groups SG. In other words, a plurality of spot groups SG can be formed in one-to-one correspondence with the plurality of light emitting element groups 295. In each spot group SG, the most upstream spot in the main scanning direction MD and the sub scanning direction SD is particularly defined to be a first spot. The light emitting element 2951 corresponding to the first spot is particularly defined to be a first light emitting element.

FIGS. 11 and 12 show a case where the spots SP are formed with the image plane kept stationary in order to facilitate the understanding of the correspondence relationship of the light emitting element groups 295, the lenses LS and the spot groups SG. Accordingly, the formation positions of the spots SP in the spot groups SG are substantially similar to the arranged positions of the light emitting elements 2951 in the light emitting element groups 295. However, as described later, an actual spot forming operation is performed while the image plane IP (surface of the photosensitive drum 21) is conveyed in the sub scanning direction SD. As a result, the spots SP formed by the plurality of light emitting elements 2951 of the head substrate 293 are formed on a straight line substantially parallel to the main scanning direction MD.

Further, spot group rows SGR and spot group columns SGC are defined as shown in the column “On Image Plane” of FIG. 12. Specifically, a plurality of spot groups SG aligned in the main scanning direction MD is defined to be the spot group row SGR. A plurality of spot group rows SGR are arranged at specified spot group row pitches Psgr in the sub scanning direction SD. Further, a plurality of (three in FIG. 12) spot groups SG arranged at the spot group row pitches Psgr in the sub scanning direction SD and at spot group pitches Psg in the main scanning direction MD are defined to be the spot group column SGC. It should be noted that the spot group row pitch Psgr is a distance in the sub scanning direction SD between the geometric centers of gravity of the two spot group rows SGR side by side with the same pitch and that the spot group pitch Psg is a distance in the main scanning direction MD between the geometric centers of gravity of the two spot groups SG side by side with the same pitch.

Lens rows LSR and lens columns LSC are defined as shown in the column of “Lens Array” of FIG. 12. Specifically, a plurality of lenses LS aligned in the longitudinal direction LGD is defined to be the lens row LSR. A plurality of lens rows LSR are arranged at specified lens row pitches Plsr in the width direction LTD. Further, a plurality of (three in FIG. 12) lenses LS arranged at the lens row pitches Plsr in the width direction LTD and at lens pitches Pls in the longitudinal direction LGD are defined to be the lens column LSC. It should be noted that the lens row pitch Plsr is a distance in the width direction LTD between the geometric centers of gravity of the two lens rows LSR side by side with the same pitch and that the lens pitch Pls is a distance in the longitudinal direction LGD between the geometric centers of gravity of the two lenses LS side by side with the same pitch.

Light emitting element group rows 295R and light emitting element group columns 295C are defined as in the column “Head Substrate” of FIG. 12. Specifically, a plurality of light emitting element groups 295 aligned in the longitudinal direction LGD is defined to be the light emitting element group row 295R. A plurality of light emitting element group rows 295R are arranged at specified light emitting element group row pitches Pegr in the width direction LTD. Further, a plurality of (three in FIG. 12) light emitting element groups 295 arranged at the light emitting element group row pitches Pegr in the width direction LTD and at light emitting element group pitches Peg in the longitudinal direction LGD are defined to be the light emitting element group column 295C. It should be noted that the light emitting element group row pitch Pegr is a distance in the width direction LTD between the geometric centers of gravity of the two light emitting element group rows 295R side by side with the sane pitch and that the light emitting element group pitch Peg is a distance in the longitudinal direction LGD between the geometric centers of gravity of the two light emitting element groups 295 side by side with the same pitch.

Light emitting element rows 2951R and light emitting element columns 2951C are defined as in the column “Light emitting element group” of FIG. 12. Specifically, in each light emitting element group 295, a plurality of light emitting elements 2951 aligned in the longitudinal direction LGD is defined to be the light emitting element row 2951R. A plurality of light emitting element rows 2951R are arranged at specified light emitting element row pitches Pelr in the width direction LTD. Further, a plurality of (two in FIG. 12) light emitting elements 2951 arranged at the light emitting element row pitches Pelr in the width direction LTD and at light emitting element pitches Pel in the longitudinal direction LGD are defined to be the light emitting element column 2951C. It should be noted that the light emitting element row pitch Pelr is a distance in the width direction LTD between the geometric centers of gravity of the two light emitting element rows 2951R side by side with the same pitch and that the light emitting element pitch Pel is a distance in the longitudinal direction LGD between the geometric centers of gravity of the two light emitting elements 2951 side by side with the same pitch.

Spot rows SPR and spot columns SPC are defined as shown in the column “Spot Group” of FIG. 12. Specifically, in each spot group SG, a plurality of spots SG aligned in the longitudinal direction LGD is defined to be the spot row SPR. A plurality of spot rows SPR are arranged at specified spot row pitches Pspr in the width direction LTD. Further, a plurality of (two in FIG. 12) spots arranged at the spot row pitches Pspr in the width direction LTD and at spot pitches Psp in the longitudinal direction LGD are defined to be the spot column SPC. It should be noted that the spot row pitch Pspr is a distance in the sub scanning direction SD between the geometric centers of gravity of the two spot rows SPR side by side with the same pitch and that the spot pitch Psp is a distance in the main scanning direction MD between the geometric centers of gravity of the two spots SP side by side with the same pitch.

Here, the configurations, the number and the positions of the lenses LS used in this specification are defined. First of all, the “lens configuration” is a concept including the shape, the thickness and the material of the lens LS. The lens positions, the lens thickness, the lens shape and the number of the lenses LS are as follows.

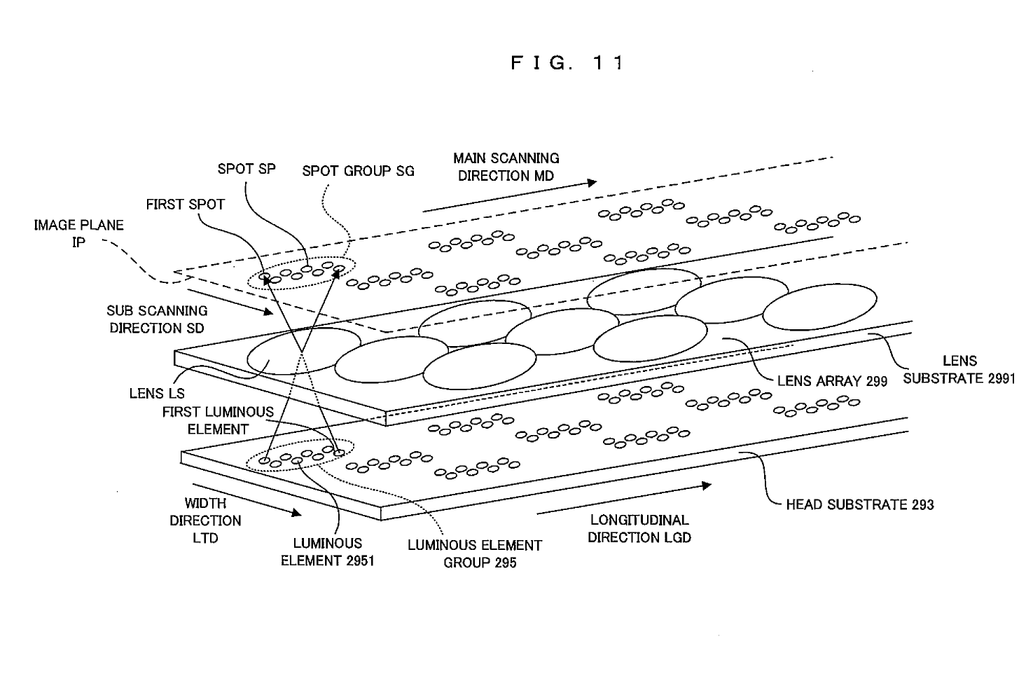

FIG. 13 is a diagram showing the lens position and the like. First, the lens position of the lens LS is the position of an apex VTf of the first surface LSFf of the lens LS in the case where an intersection of an arrangement plane of the light emitting element group 295 corresponding to the lens LS (under surface of the head substrate 293 in this embodiment) and the optical axis OA is assumed to be an origin. Here, the apex VTf is an intersection of the first surface LSFf of the lens LS and the optical axis OA. The lens thickness THK of the lens LS is an inter-surface distance between the first surface LSFf and the second surface LSFs of the lens LS. Specifically, as shown in FIG. 13A, the lens thickness THK is a distance between the apex VTf of the first surface LSFf of the tens LS and the apex VTs of the second surface LSFs of the lens LS. The apex VTs is an intersection of the second surface LSs of the lens LS and the optical axis OA. The lens shape of the lens LS is defined by the shapes of the first and second surfaces LSFf, LSFs of the lens LS. Thus, lenses having at least either the first surface LSFf or the second surface LSFs differing in shape have different lens shapes. The number of the lenses LS is the number of the lenses provided corresponding to one light emitting element group 295 and is one in FIG. 13.

FIG. 14 is a diagram showing a spot forming operation by the above-described line head. The spot forming operation by the line head of this embodiment is described below with reference to FIGS. 2, 7 and 14. In order to facilitate the understanding of the invention, there is described a case where a plurality of spots are aligned on a straight line extending in the main scanning direction MD. In this embodiment, the plurality of spots are formed on the straight line extending in the main scanning direction MD by causing a plurality of light emitting elements to emit lights at specified timings by means of the head control module 54 while the surface of the photosensitive drum 21 (latent image carrier) is conveyed in the sub scanning direction SD.

Specifically, in the line head of this embodiment, six light emitting element rows 2951R are arranged in the width direction LTD corresponding to width-direction positions LTD1 to LTD6 (FIG. 7). Thus, in this embodiment, the light emitting element rows 2951R located at the same width-direction position are driven to emit lights substantially at the same timing, and those located at different width-direction positions are caused to emit lights at mutually different timings. More specifically, the light emitting element rows 2951R are driven to emit lights in an order of the width-direction positions LTD1 to LTD6. By driving the light emitting element rows 2951R to emit lights in the above order while the surface of the photosensitive drum 21 is conveyed in the sub scanning direction SD corresponding to the width direction LTD, the plurality of spots are formed while being aligned on the straight line extending in the main scanning direction MD of this surface.

Such an operation is described with reference to FIGS. 7 and 14. First of all, the light emitting elements 2951 of the light emitting element rows 2951R at the width-direction position LTD1 belonging to the most upstream light emitting element groups 295_C1, 295_C2, 295_C3, . . . in the width direction LTD corresponding to the sub scanning direction SD are driven to emit lights. A plurality of light beams emitted by such a light emitting operation are focused on the photosensitive drum surface in an inverted manner by the lenses LS having the above-mentioned inverting property. In other words, spots are formed at hatched positions of the “first operation” of FIG. 14. In FIG. 14, white circles represent spots that are not formed yet, but planned to be formed later. In FIG. 14, spots labeled by reference numerals 295_C1, 295_B1, 295_A1 and 295_C2 are those to be formed by the light emitting element groups 295 corresponding to the respective attached reference numerals.

Subsequently, the light emitting elements 2951 of the light emitting element rows 2951R at the width-direction position LTD2 belonging to the same light emitting element groups 295_C1, 295_C2, 295_C3, . . . are driven to emit lights. A plurality of light beams emitted by such a light emitting operation are focused on the photosensitive drum surface in an inverted manner by the lenses LS having the above-mentioned inverting property. In other words, spots are formed at hatched positions of the “second operation” of FIG. 14. Here, whereas the surface of the photosensitive drum 21 is conveyed in the sub scanning direction SD, the light emitting element rows 2951R are successively driven to emit lights from the downstream ones in the width direction LTD corresponding to the sub scanning direction SD (that is, in the order of the width-direction positions LTD1, LTD2). This is to deal with the inverting property of the lenses LS.

Subsequently, the light emitting elements 2951 of the light emitting element rows 2951R at the width-direction position LTD3 belonging to the second most upstream light emitting element groups 295_B1, 295_B2, 295_B3, . . . in the width direction LTD are driven to emit lights. A plurality of light beams emitted by such a light emitting operation are focused on the photosensitive drum surface in an inverted manner by the lenses LS having the above-mentioned inverting property. In other words, spots are formed at hatched positions of the “third operation” of FIG. 14.

Subsequently, the light emitting elements 2951 of the light emitting element rows 2951R at the width-direction position LTD4 belonging to the same light emitting element groups 295_B1, 295_B2, 295_B3, . . . are driven to emit lights. A plurality of light beams emitted by such a light emitting operation are focused on the photosensitive drum surface in an inverted manner by the lenses LS having the above-mentioned inverting property. In other words, spots are formed at hatched positions of the “fourth operation” of FIG. 14.

Subsequently, the light emitting elements 2951 of the light emitting element rows 2951R at the width-direction position LTD5 belonging to the most downstream light emitting element groups 295_A1, 295_A2, 295_A3, . . . in the width direction LTD are driven to emit lights. A plurality of light beams emitted by such a light emitting operation are focused on the photosensitive drum surface in an inverted manner by the lenses LS having the above-mentioned inverting property. In other words, spots are formed at hatched positions of the “fifth operation” of FIG. 14.

Finally, the light emitting elements 2951 of the light emitting element rows 2951R at the width-direction position LTD6 belonging to the same light emitting element groups 295_A1, 295_A2, 295_A3, . . . are driven to emit lights. A plurality of light beams emitted by such a light emitting operation are focused on the photosensitive drum surface in an inverted manner by the lenses LS having the above-mentioned inverting property. In other words, spots are formed at hatched positions of the “sixth operation” of FIG. 14. By performing the first to sixth light emitting operations in this way, a plurality of spots are formed while being aligned on the straight line extending in the main scanning direction MD.

As described above, in this embodiment, the plurality of light emitting elements 2951 are arranged at mutually different positions in the longitudinal direction LGD in each light emitting element group and two light emitting elements for emitting lights to form adjacent spots are arranged at mutually different positions in the width direction LTD. The spots SP are formed while being aligned in the main scanning direction MD by focusing the light beams emitted from the light emitting elements 2951 driven at timings in conformity with the movement of the photosensitive drum 21 in the sub scanning direction SD at mutual different positions of the photosensitive drum surface in the main scanning direction MD.

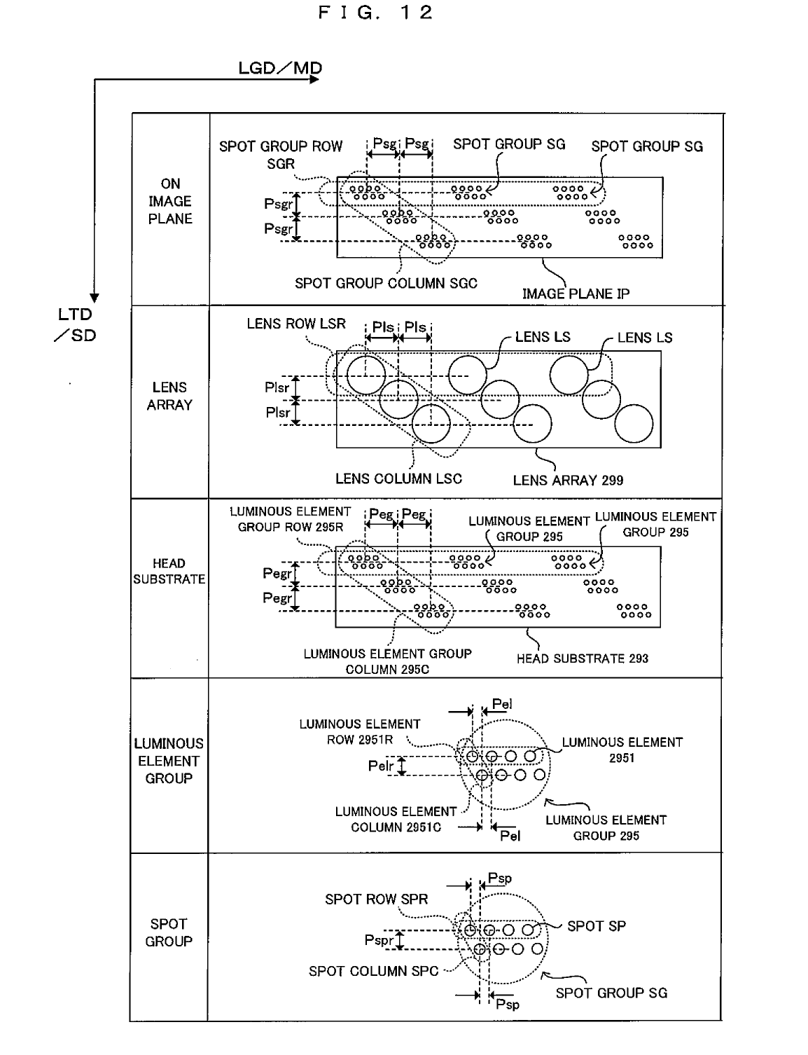

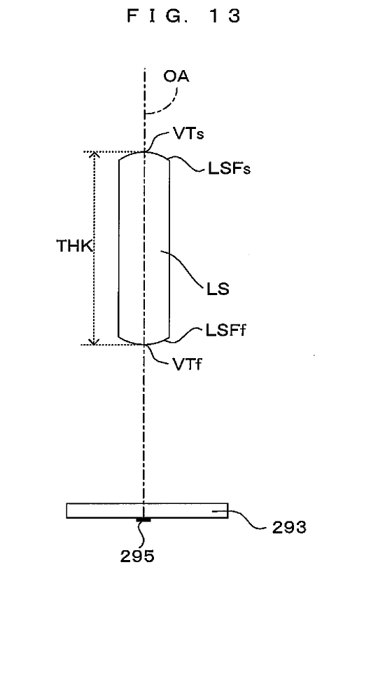

FIG. 15 is a sectional view along the sub scanning direction showing the relationship of arrangement of the line head and the photosensitive drum. An upper side of FIG. 15 enlargedly shows a rectangular part enclosed by broken line in a lower side of FIG. 15. FIG. 16 is a sectional view along the sub scanning direction showing the relationship of arrangement of the lens array the line head includes and the photosensitive drum. In other words, FIGS. 15 and 16 both show the relationship of arrangement of the line head and the photosensitive drum viewed from the longitudinal direction LGD. Hereinafter, a problem that occurs upon forming spots on the photosensitive drum 21 with the above-described line head 29 is described through the description of the relationship of arrangement of the line head 29 and the photosensitive drum 21.

Three lens rows LSR1 to LSR3 are arranged at mutually different arrangement positions AP1 to AP3 in the width direction LTD. More specifically, the three lens rows LSR1 to LSR3 are arranged at lens row pitches Plsr in the width direction LTD and substantially symmetrical with respect to a symmetry axis SA in the width direction LTD. The lens rows LSR1 to LSR3 are arranged such that optical axes OA1 to OA3 of the lenses LS belonging respectively thereto are parallel to each other. In FIG. 16, the optical axis OA2 of the lens LS2 coincides with the symmetry axis SA. The lens array 299 is arranged such that the symmetry axis SA passes a curvature center CC21 of the shape of the surface of the photosensitive drum 21. Therefore, the symmetry axis SA passes the rotation axis of the photosensitive drum 21.

The lens rows LSR1 to LSR3 are all arranged to face the surface of the photosensitive drum 21. At this time, the respective lens rows LSR1 to LSR3 face facing positions FCP1 to FCP3 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1. As a result, the light beam LB1 is focused on a focus position FP1. The lens LS2 belonging to the lens row LSR2 focuses a light beam LB2 emitted from a light emitting element group 295, which the lens LS2 is facing, toward the facing position FCP2. As a result, the light beam LB2 is focused on a focus position FP2. The lens LS3 belonging to the lens row LSR3 focuses a light beam LB3 emitted from a light emitting element group 295, which the lens LS3 is facing, toward the facing position FCP3. As a result, the light beam LB3 is focused on a focus position FP3. In other words, the focus positions FP of the light beams focused by the lenses LS belonging to the different lens rows LSR mutually differ in the sub scanning direction SD. Here, the focus position FP is the position and its vicinity where the light beam LB having passed through the lens LS forms an image with a minimum spot diameter.

Here, the focus positions FP1 to FP3 of the respective light beams LB1 to LB3 are considered in the case where all the lenses LS the lens array 299 includes have the same lens position and lens configuration. In this case, the focus positions FP1 to FP3 of the respective light beams LB1 to LB3 are located in the same plane SPL_fp which is substantially parallel to the sub scanning direction SD (the width direction LTD) in the section along the sub scanning direction. On the other hand, a surface region FCR facing the lens array 299 out of the surface of the photosensitive drum 21 (latent image carrier) has a curvature in the section along the sub scanning direction as shown in FIGS. 15 and 16. Accordingly, when distances between the respective focus positions FP1 to FP3 and the surface of the photosensitive drum 21 are defined as image-photosensitive member distances fd1 to fd3, there occurs a difference among the image-photosensitive member distances fd1 to fd3. In other words, the image-photosensitive member distance between the focus position FP and the photosensitive drum surface differ among the plurality of lens rows LSR1 to LSR3. Because of such a difference of the image-photosensitive member distance, images formed on the surface of the photosensitive drum 21 differ depending on the lens row LSR. As a result, there is a possibility of an occurrence of an exposure failure of being unable to perform a satisfactory exposure. Here, each of the image-photosensitive member distances fd1 to fd3 is a distance between the focus position FP and the photosensitive drum surface in the direction of the optical axis OA of the lens LS corresponding to the focus position FP.

Next, the above-described exposure failure is described using a more specific comparative example 1 in order to facilitate the understanding of the invention. In other words, the specific content of the exposure failure is described through a simulation result on the relationship of arrangement of the photosensitive drum 21 and the line head 29 as shown in FIGS. 15 and 16 in the case where all the lenses LS have the same lens configuration and lens position.

### Comparative Example 1

FIG. 17 shows the lens data of the lens LS used in the simulation of the comparative example 1. Surface numbers S1 to S6 are described with reference to FIGS. 9 and 10. The surface number S1 corresponds to an object plane, that is, the under surface of the head substrate 293 where the light emitting elements 2951 are arranged. The surface number S2 corresponds to the top surface of the head substrate 293. The surface number S3 corresponds to a plane where the aperture diaphragm DIA is arranged (aperture plane). As described above, the aperture diaphragm DIA is arranged at the front focus of the lens LS to realize an image side telecentric system. The surface number S4 corresponds to the first surface LSFf of the lens LS. The surface number S5 corresponds to the second surface LSFs of the lens LS. The surface number S6 corresponds to the image plane IP, that is, the surface of the photosensitive drum (latent image carrier). Here, the sum of the surface intervals from the surface number S1 to the surface number S3 gives the lens position and the surface interval of the surface number S4 gives the lens thickness.

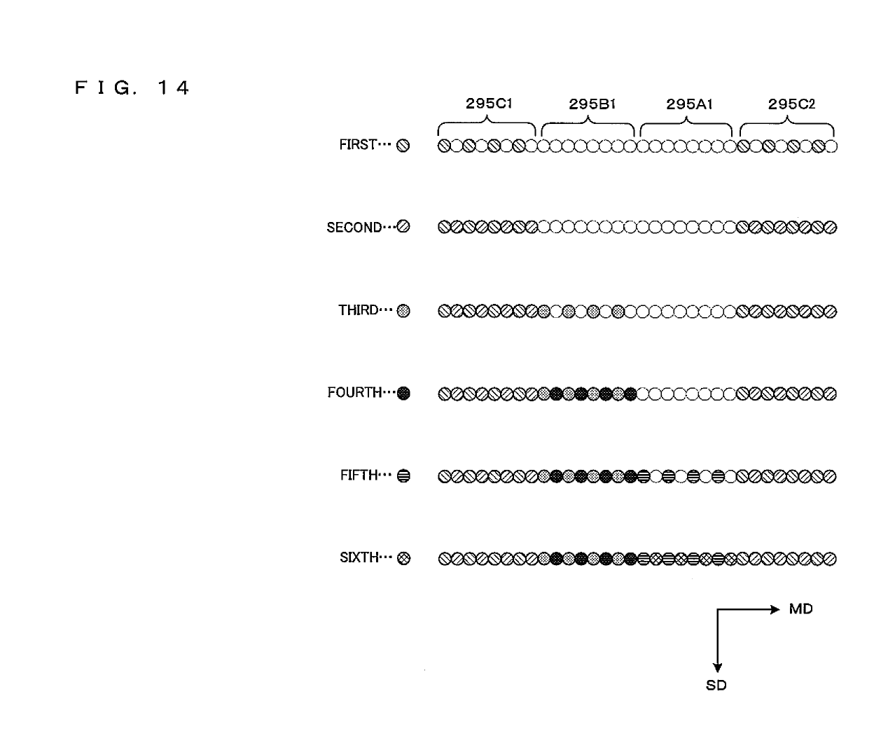

FIG. 18 shows aspherical surface coefficients of the aspherical surfaces S4, S5. Equation (1) gives a shape of the aspherical surface. In other words, the shapes of the aspherical surfaces S4, S5 (that is, the lens shape of the lens LS) are determined by FIG. 18 and the equation (1).

Z=(CURV)h²/[1+{1−(1+K)(CURV)²h²}^{1/2}]+(A)h (1)

where Z represents a sagitta of a plane parallel to axis z, CURV represents a curvature at the apex of the surface, K represents a conic coefficient, A represents a deforming coefficient of fourth order. And, h²=x²+y², where x represents a coordinate of x axis (main scanning direction) and y represents a coordinate of y axis (sub scanning direction).

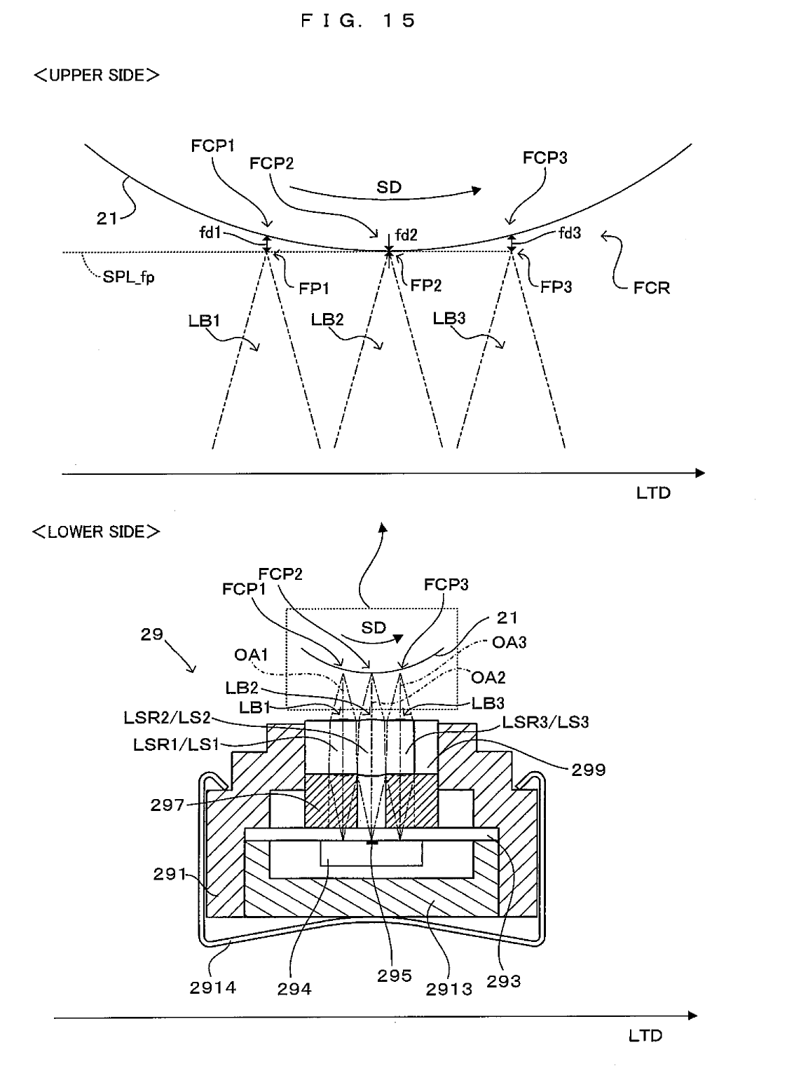

FIG. 19 shows the specification of an optical system used in the simulation of the comparative example 1. Here, wavelength is that of light beams emitted from the light emitting elements. The lens diameter is the diameter of an emergence surface, that is, the second surface LSFs of the lens LS. A light source diameter is the diameter of the light emitting elements 2951. An object height of 0.6 mm in this specification means that the simulation was conducted on the condition that the light beam is emitted from a virtual light emitting element located at an object height of 0.6 mm. At this time, an image height is −0.3 mm since magnification is −0.5.

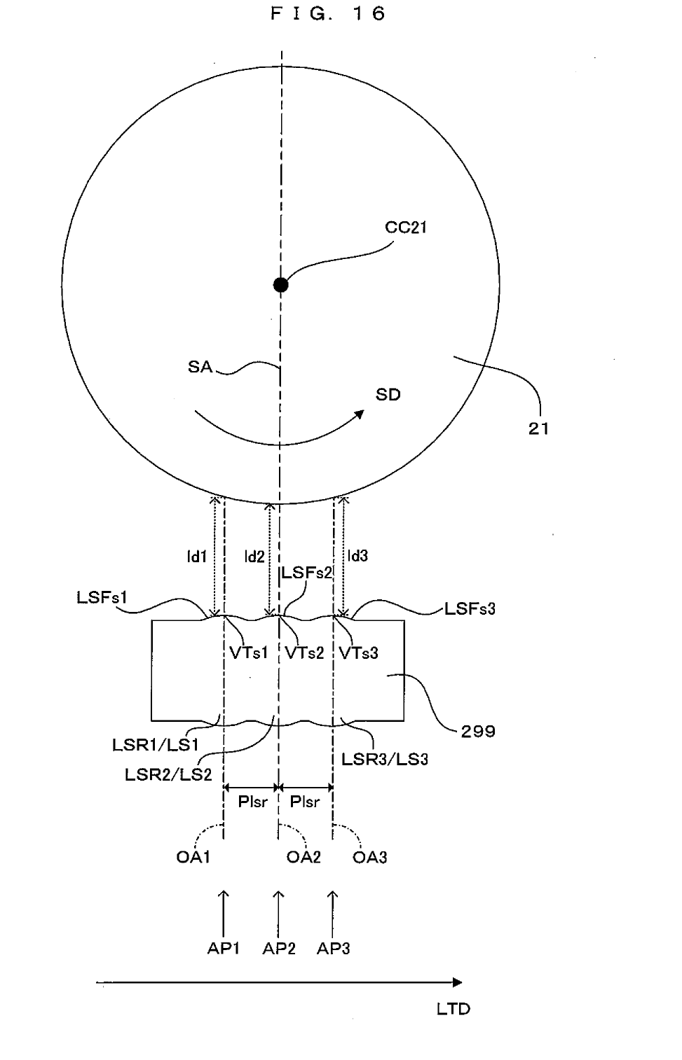

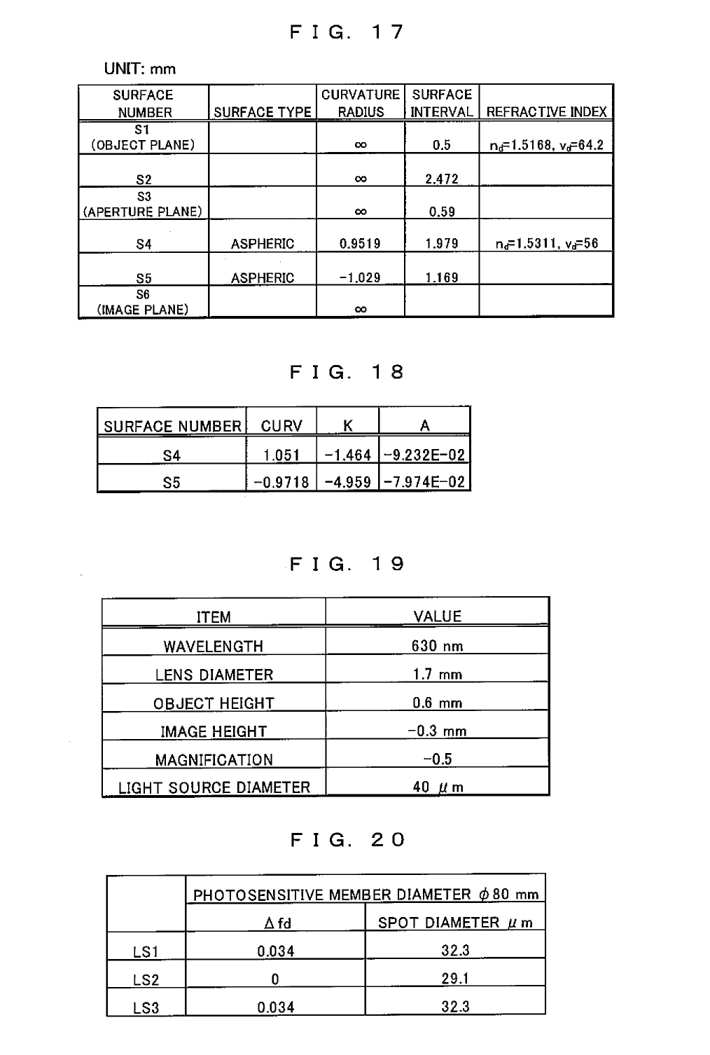

FIG. 20 shows a simulation result in the case where all the lenses LS1 to LS3 are formed based on the data given by above FIG. 17 to FIG. 19 and the equation (1). In this simulation, a lens row pitch Plsr and a light emitting element group row pitch Pegr are 1.65 mm, and a photosensitive drum diameter is 80 mm. Differences Δfd shown in FIG. 20 are differences between image-photosensitive member distances fd1 to fd3 corresponding to the lenses LS1 to LS3 and the image-photosensitive member distance fd2. In other words, the differences Δfd among the image-photosensitive member distances fd1 to fd3 are calculated based on the image-photosensitive member distance fd2.

As shown in FIG. 20, there occurs a differences Δfd of 0.034 mm between the image-photosensitive member distance fd1 corresponding to the lens LS1 and the image-photosensitive member distance fd2 corresponding to the lens LS2. And, there occurs a differences Δfd of 0.034 mm between the image-photosensitive member distance fd3 corresponding to the lens LS3 and the image-photosensitive member distance fd2 corresponding to the lens LS2. Such a difference Δfd among the image-photosensitive member distances fd1 to fd3 results from the fact that the photosensitive drum 21 has a curvature in the section along the sub scanning direction as described above. As shown by spot diameters in FIG. 20 column, the diameters of the spots formed on the surface of the photosensitive drum 21 differ among the lenses LS1 to LS3 due to the differences among the image-photosensitive member distances fd1 to fd3. Specifically, the value of the diameters of the spots formed by the lens LS2 is 29.1 μm, whereas the values of the diameters of the spots formed by the lenses LS1 and LS3 are 32.3 μm. Accordingly, there is a difference of 3.2 μm (=32.3 μm−29.1 μm) between the diameter of the spots formed by the lens LS2 and the diameters of the spots formed by the lenses LS1, LS3. In other words, there occurs an exposure failure that the diameters of the spots to be formed differ among the plurality of lens rows LSR1 to LSR3.

As described using the comparative example 1, the image-photosensitive member distances fd1 to fd3 differ because the photosensitive drum 21 has a curvature in the section along the sub scanning direction. As a result, there occurs differences in the diameters of the spots formed on the surface of the photosensitive drum 21. In the line head 29 used in the invention, a plurality of clear members CM are arranged corresponding to the plurality of lenses LS to cope with such a problem. Here, a description is made using a specific working example 1 in order to facilitate the understanding of the invention.

### Working Example 1

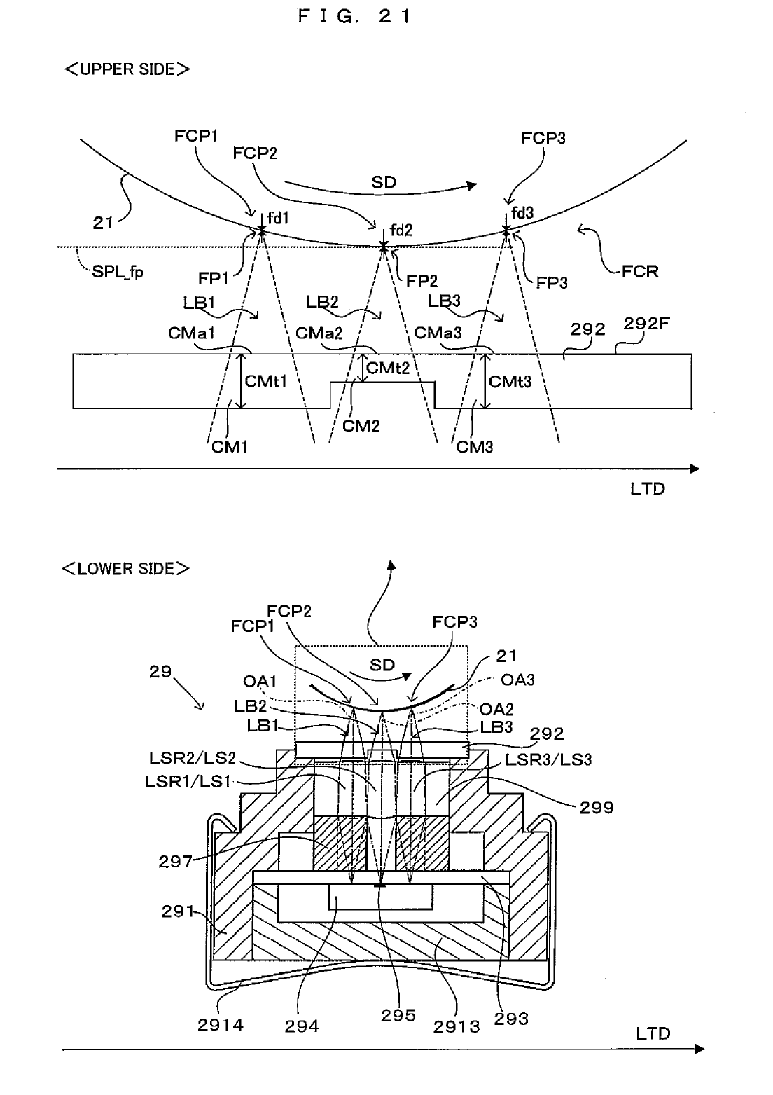

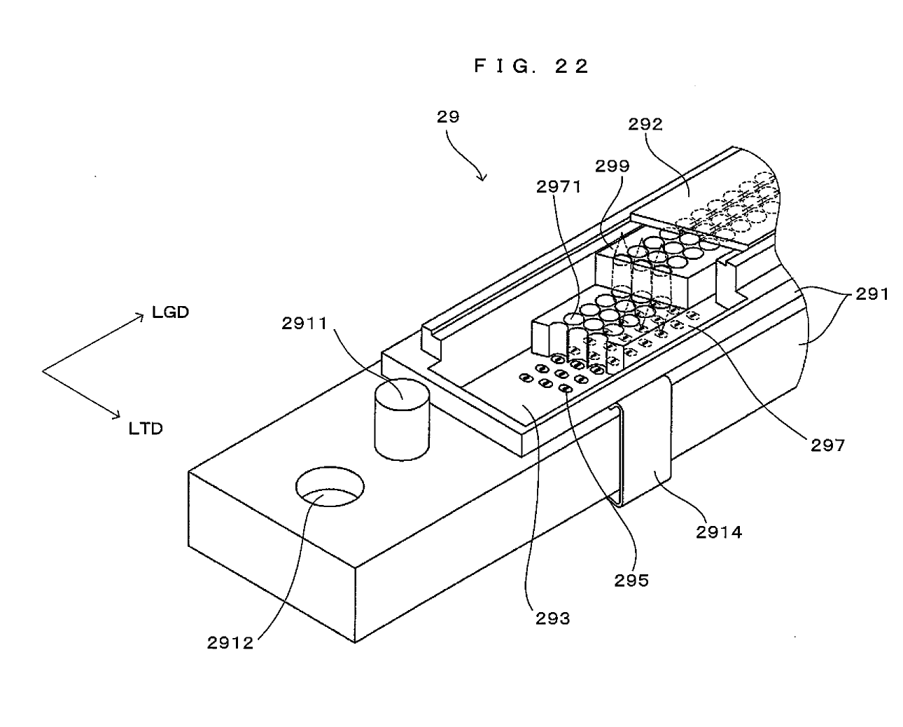

FIG. 21 is a sectional view along the sub scanning direction showing the relationship of arrangement of a line head and a photosensitive drum according to a working example 1 of the invention. An upper side of FIG. 21 enlargedly shows a rectangular part enclosed by broken line in a lower side of FIG. 21. Lenses LS1 to LS3 in the lower side of FIG. 21 are lenses belonging to mutually different lens rows LSR1 to LSR3. FIG. 22 is a perspective view of the line head in the working example 1. The line head shown in FIG. 22 differs from the line head shown in FIG. 3 only in the fact of including a clear substrate 292 (described in detail later), and other construction is the same as the line head shown in FIG. 3.

In the working example 1, the relationship of arrangement of the lens array 299 and the photosensitive drum 21 is the same as in the comparative example 1. Specifically, as described with reference to FIG. 16, three lens rows LSR1 to LSR3 are arranged at lens row pitches Plsr in the width direction LTD and are substantially symmetrically arranged in the width direction LTD with respect to a symmetry axis SA. Further, the lens rows LSR1 to LSR3 are arranged such that optical axes OA1 to OA3 of the lenses LS1 to LS3 belonging to the lens rows LSR1 to LSR3 are parallel to each other. The lens array 299 is arranged such that the symmetry axis SA passes a curvature center CC21 of the photosensitive drum 21 (that is, rotation axis of the photosensitive drum 21).

In the working example 1, a plurality of clear members are arranged corresponding to the plurality of lenses LS. In other words, in the line head 29 in the working example 1, each of the plurality of clear members CM is arranged between the lens LS to which the clear member CM corresponds and the photosensitive drum surface (latent image carrier surface). Accordingly, each of the plurality of lenses LS focuses a light beam emitted from a light emitting element 2951 of a light emitting element group 295, to which the lens LS corresponds, toward the photosensitive drum surface the lens LS faces via a clear member CM to which the lens LS corresponds. Here, each of the plurality of clear members CM has a specified member thickness in the direction of the optical axis of the lens LS to which the clear member CM corresponds.

In other words, as shown in FIG. 21, a clear member CM1 is arranged corresponding to the lens LS1, a clear member CM2 is arranged corresponding to the lens LS2, and a clear member CM3 is arranged corresponding to the lens LS3. And the clear members CM1 to CM3 have member thicknesses CMt1 to CMt3, respectively. Further, as shown in FIG. 21, in the working example 1, the plurality of clear members CM1 to CM3 are integrally joined with each other to form a single clear substrate 292. Furthermore, the plurality of clear members CM1 to CM3 are formed such that respective clear member surfaces CMa1 to CMa3 thereof which are surfaces of the photosensitive drum side are flush with each other.

The lens rows LSR1 to LSR3 are all arranged to face the surface of the photosensitive drum 21. At this time, the respective lens rows LSR1 to LSR3 face facing positions FCP1 to FCP3 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1 via the clear member CM1. The lens LS2 belonging to the lens row LSR2 focuses a light beam LB2 emitted from a light emitting element group 295, which the lens LS2 is facing, toward the facing position FCP2 via the clear member CM2. The lens LS3 belonging to the lens row LSR3 focuses a light beam LB3 emitted from a light emitting element group 295, which the lens LS3 is facing, toward the facing position FCP3 via the clear member CM3. In other words, the focus positions of the light beams focused by the lenses LS belonging to the different lens rows LSR mutually differ in the sub scanning direction SD. Accordingly, there is a possibility that an exposure failure as shown in the comparative example 1 occurs.

On the contrary, in the working example 1 of the invention, the focus positions FP1 to FP3 of the light beams by the lenses LS1 to LS3 are set at positions in conformity with the curvature shape of the surface of the photosensitive drum 21 (FIG. 21). The member thicknesses CMt1 to CMt3 of the plurality of clear members are determined such that the focus positions FP1 to FP3 of the light beams LB1 to LB3 transmissive through the plurality of clear members CM1 to CM3 respectively are in conformity with the positions corresponding to the curvature shape of the photosensitive drum surface to conform the focus positions FP1 to FP3 to the curvature shape in this way. This construction is specifically as follows.

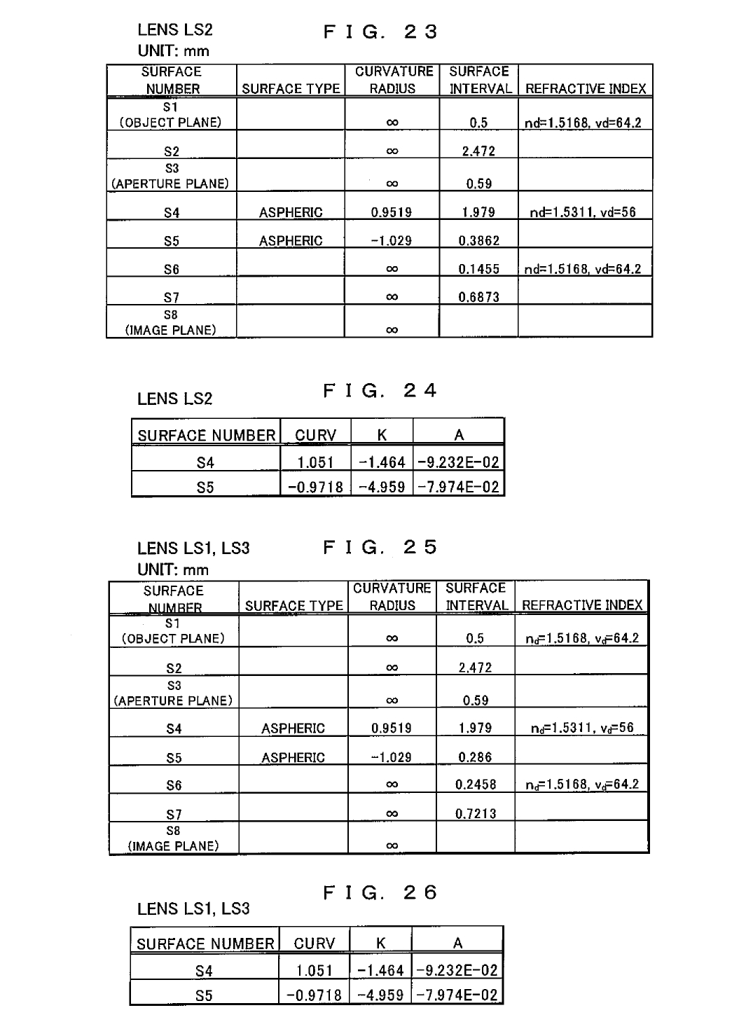

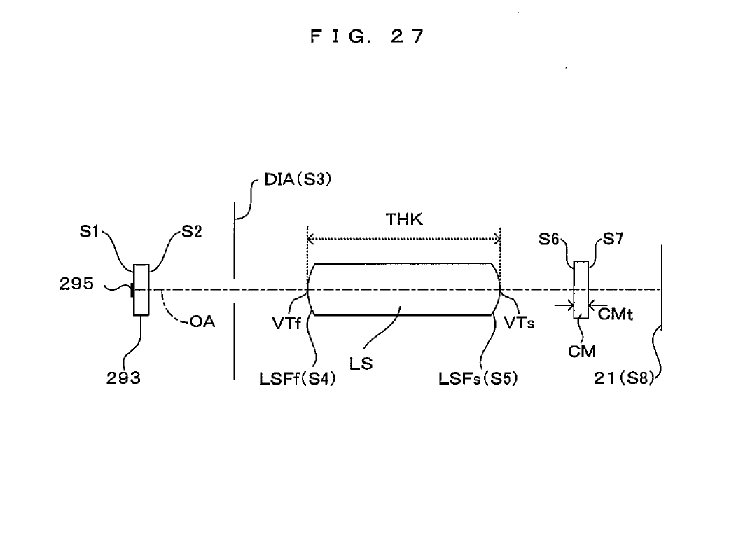

FIG. 23 shows the lens data of the lens LS2, and FIG. 24 shows the aspherical surface coefficient of the lens LS2. On the other hand, FIG. 25 shows the lens data of the lenses LS1, LS3, and FIG. 26 shows the aspherical surface coefficients of the lenses LS1, LS3. FIG. 27 is a diagram describing surface numbers and surfaces corresponding thereto in the working example 1. The surface number S1 corresponds to an object plane, that is, the under surface of the head substrate 293 where the light emitting elements 2951 are arranged. The surface number S2 corresponds to the top surface of the head substrate 293. The surface number S3 corresponds to a plane where the aperture diaphragm DIA is arranged (aperture plane). As described above, the aperture diaphragm DIA is arranged at the front focus of the lens LS to realize an image side telecentric system. The surface number S4 corresponds to the first surface LSFf of the lens LS. The surface number S5 corresponds to the second surface LSFs of the lens LS. The surface number S6 corresponds to the under surface of the clear member CM (in other words, clear member surface of the lens side). The surface number S7 corresponds to the top surface of the clear member CM (in other words, clear member surface of the latent image carrier side). Accordingly, the surface interval of the surface number S6 gives the member thickness CMt of the clear member CM. Further, the surface number S8 corresponds to the image plane IP, that is, the surface of the photosensitive drum (latent image carrier).

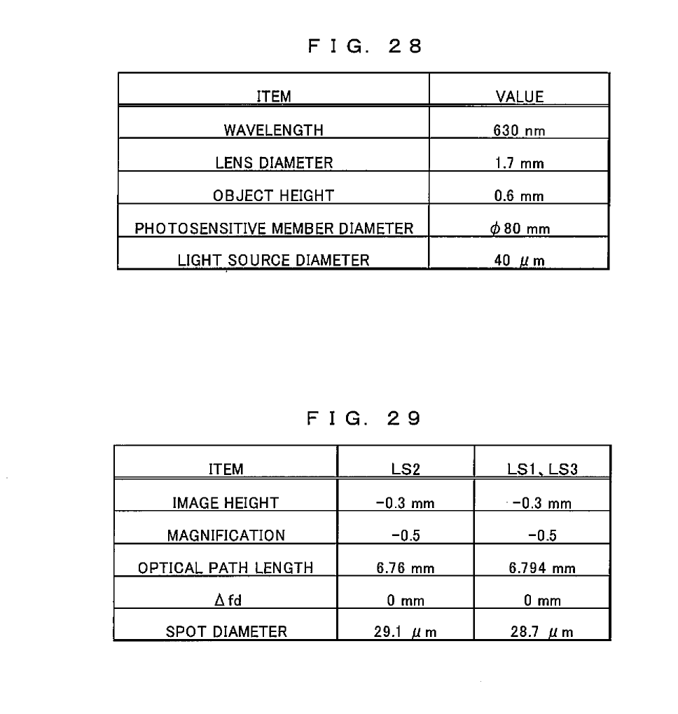

As can be understood from FIG. 23 to FIG. 26, the member thicknesses CMt of the corresponding clear members CM differ between the lens LS2 and the lenses LS1, LS3 in the working example 1. Specifically, the member thickness CMt2 of the clear member CM2 corresponding to the lens LS2 is 0.1455 mm, whereas the member thicknesses CMt1, CMt3 of the clear members CM1, CM3 corresponding to the lenses LS1, LS3 are 0.2458 mm. All of the lenses LS1 to LS3 have the same lens configuration and lens position. FIG. 28 shows the specification of an optical system used in a simulation of the working example 1.

FIG. 29 shows a simulation result executed based on the data given by above FIG. 23 to FIG. 28. In this simulation, a lens row pitch Plsr, a light emitting element group row pitch Pegr, a photosensitive drum diameter and other conditions are the same as in the comparative example 1. Optical path lengths in FIG. 29 are those from the position of an object height of 0.6 mm to the positions of image heights of −0.3 mm corresponding to the respective lenses LS1 to LS3. Differences Δfd shown in FIG. 29 are differences between image-photosensitive member distances fd1 to fd3 corresponding to the lenses LS1 to LS3 and the image-photosensitive member distance fd2. In other words, the differences Δfd among the image-photosensitive member distances fd1 to fd3 are calculated based on the image-photosensitive member distance fd2. As shown in FIG. 29, the differences Δfd are 0 in the working example 1. In other words, the image-photosensitive member distances fd1 to fd3 are equal to each other. This is because the focus positions FP1 to FP3 of the light beams by the lenses LS1 to LS3 are set to the positions in conformity with the curvature shape of the photosensitive drum 21 (substantially on the surface of the photosensitive drum 21 as shown in FIG. 21 in the working example 1) as shown in FIG. 21. As shown in a column “Spot Diameter” of FIG. 29, it can be understood that differences in the diameters of spots formed on the surface of the photosensitive drum 21 are suppressed by suppressing the differences of the image-photosensitive member distances fd1 to fd3. Specifically, the diameter of the spots formed by the lens LS2 is 29.1 μm, whereas the diameter of the spots formed by the lenses LS1, LS3 is 28.7 μm. Accordingly, a spot diameter difference in the working example 1 is 0.4 μm (=29.1 μm−28.7 μM) and an improvement as compared to the spot diameter difference of 3.2 μm in the comparative example 1 can be understood. In other words, an occurrence of an exposure failure that the diameters of the formed spots differ among a plurality of lens rows LSR1 to LSR3 is suppressed in the working example 1 as compared to the comparative example 1.

In this way, in the working example 1, the member thicknesses CMt1 to CMt3 of the plurality of clear members CM1 to CM3 are determined such that the focus positions FP1 to FP3 of the light beams LB1 to LB3 transmissive through the plurality of respective clear members CM1 to CM3 conform to the curvature shape of the photosensitive drum surface. Accordingly, an occurrence of such a problem that the distances (the image-photosensitive member distances fd) between the focus positions FP1 to FP3 and the photosensitive drum surface differ depending on the plurality of lens rows LSR1 to LSR3 as described above can be suppressed. As a result, a satisfactory exposure can be advantageously realized by the invention.

In the working example 1, the lens array 299 is constructed such that the respective lenses LS have the same lens configuration and are arranged at the same lens positions. In other words, in the working example 1, the construction of the lens array 299 is simplified. As a result, the construction of the line head is simple, and the cost reduction of the line head 29 is easy. In the working example 1, a “lens system” of the invention thus includes one lens LS.

Incidentally, in an image forming apparatus in which the developer 25 (developing unit) develops an electrostatic latent image formed by exposing the photosensitive drum surface with toner as described above, there is a possibility of occurring a following problem due to toner (scattered-toner) scattered from the photosensitive drum surface. Specifically, as shown in FIG. 6, since a plurality of lenses LS are arranged on the lens array 299, a surface of the lens array 299 is not flat but in a substantially concavo-convex shape. Accordingly, the scattered-toner tends to accumulate especially on a concave portion (region CON between the two lenses LS adjacent to each other) out of the surface of the lens array 299. Furthermore, as shown in FIG. 1, such an accumulation of the scattered-toner tends to occur in a structure that the line head 29 is disposed vertically below the photosensitive drum 21. When the scattered-toner adheres to the surface of the lens array 299 to accumulate, a light quantity of the light beam LB transmissive through the lens array 299 decreases, which leads to a decrease of a light quantity of the light beam LB contributing to the exposure of the photosensitive drum surface, and to a possibility of being unable to execute an excellent exposure.

To cope with such a problem, in the working example 1, a clear substrate 292, which is optically transmissive, is arranged between the photosensitive drum surface and the second surface LSFs (lens surface) of the lens LS facing the photosensitive drum 21. The clear substrate 292 has an opposed surface 292F opposed to the photosensitive drum surface, and the opposed surface 292F is a continuous surface without a concavo-convex shape, in other words, the opposed surface 292F is a smooth surface. Here, a concavo-convex shape is a shape formed with a combination of a convex portion and a concave portion, and does not include a shape formed only with either one of a convex portion and a concave portion.

In other words, toner scattered from the photosensitive drum surface toward the lens array 299 reaches the clear substrate 292 before reaching the lens array 299. Furthermore, the opposed surface 292F of the clear substrate 292 is a continuous surface without a concavo-convex shape, which is hard for the scattered-toner to adhere and accumulate. Hence, in the working example 1, an occurrence of the problem that a light quantity of the light beam contributing to the exposure of the photosensitive drum surface decreases due to the scattered-toner is suppressed, and it is possible to execute an excellent exposure.

Further, in the working example 1, the opposed surface 292F of the clear substrate 292 is flat, which is advantageous in suppressing an adhesion and an accumulation of the scattered-toner. In other words, the opposed surface 292F of the working example 1 has a shape hard for the scattered-toner to adhere and accumulate as compared to the case where the opposed surface is concave for instance, which is preferable.

In the above comparative example 1 and working example 1, the invention is described using the line head 29 in which the three lens rows LSR are arranged in the width direction LTD. However, the number of the lens rows is not limited to this and may be four or more. Accordingly, a case using a line head 29 with four lens rows is described. In the following description, an occurrence of the above-described exposure failure in the case where there are four lens rows (comparative example 2) is described with reference to a simulation result. Following the description of such a comparative example 2, a specific example of the invention is described (working example 2) with reference to a simulation result.

### Comparative Example 2

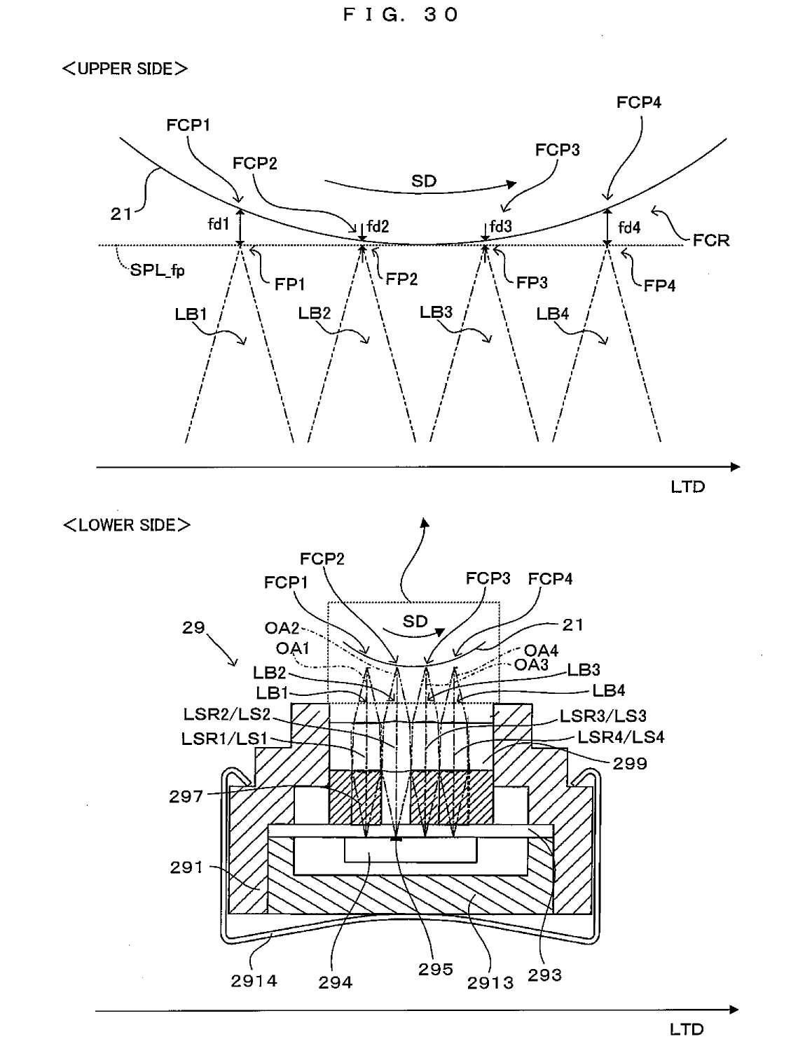

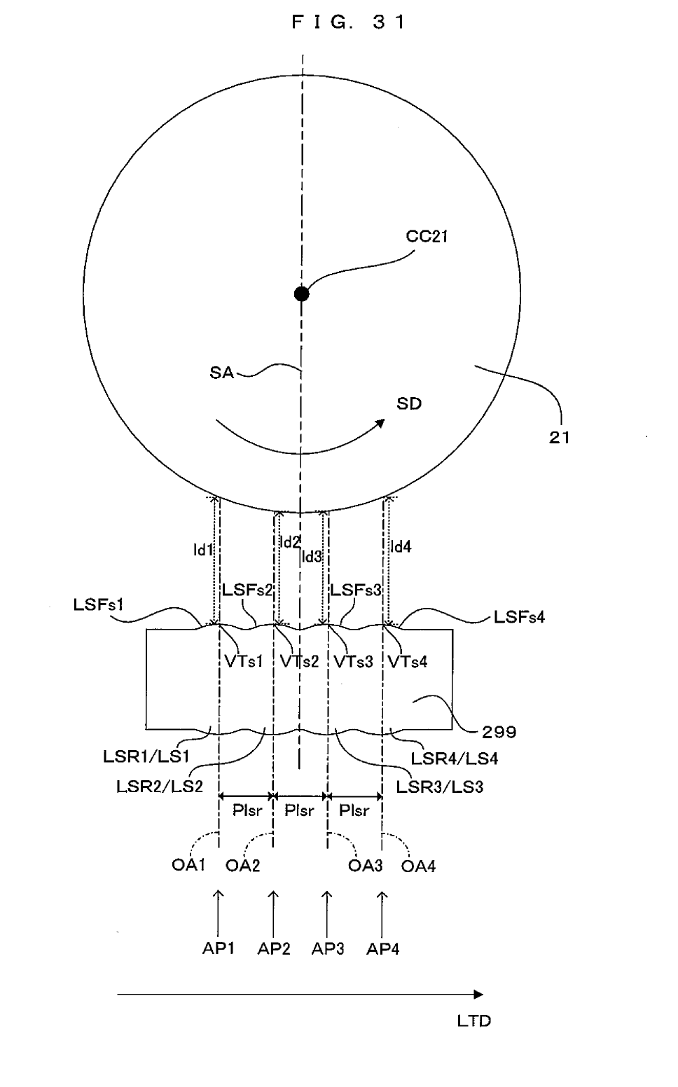

FIG. 30 is a sectional view along the sub scanning direction showing the relationship of arrangement of the line head and the photosensitive drum in the comparative example 2. An upper side of FIG. 30 enlargedly shows a rectangular part enclosed by broken line in a lower side of FIG. 30. FIG. 31 is a sectional view along the sub scanning direction showing the relationship of arrangement of the lens array the line head includes and the photosensitive drum. In other words, FIGS. 30 and 31 both show the relationship of arrangement of the line head and the photosensitive drum viewed from the longitudinal direction LGD. Hereinafter, a problem that occurs upon forming spots on the photosensitive drum 21 with the above-described line head 29 is described through the description of the relationship of arrangement of the line head 29 and the photosensitive drum 21.

Four lens rows LSR1 to LSR4 are arranged at mutually different arrangement positions AP1 to AP4 in the width direction LTD. More specifically, the four lens rows LSR1 to LSR4 are arranged at lens row pitches Plsr in the width direction LTD and substantially symmetrical with respect to a symmetry axis SA in the width direction LTD. The lens rows LSR1 to LSR4 are arranged such that optical axes OA1 to 0A4 of the lenses LS belonging respectively thereto are parallel to each other. The lens array 299 is arranged such that the symmetry axis SA passes a curvature center CC21 of the shape of the surface of the photosensitive drum 21. Therefore, the symmetry axis SA passes the rotation axis of the photosensitive drum 21.

The lens rows LSR1 to LSR4 are all arranged to face the surface of the photosensitive drum 21. At this time, the respective lens rows LSR1 to LSR4 face facing positions FCP1 to FCP4 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1. The lens LS2 belonging to the lens row LSR2 focuses a light beam LB2 emitted from a light emitting element group 295, which the lens LS2 is facing, toward the facing position FCP2. The lens LS3 belonging to the lens row LSR3 focuses a light beam LB3 emitted from a light emitting element group 295, which the lens LS3 is facing, toward the facing position FCP3. The lens LS4 belonging to the lens row LSR4 focuses a light beam LB4 emitted from a light emitting element group 295, which the lens LS4 is facing, toward the facing position FCP4. In other words, the focus positions FP of the light beams focused by the lenses LS belonging to the different lens rows LSR mutually differ in the sub scanning direction SD.

Here, the focus positions FP1 to FP4 of the respective light beams LB1 to LB4 are considered in the case where all the lenses LS the lens array 299 includes have the same lens position and lens configuration. In this case, the focus positions FP1 to FP4 of the respective light beams LB1 to LB4 are located in the same plane SPL_fp which is substantially parallel to the sub scanning direction SD (the width direction LTD) in the section along the sub scanning direction. On the other hand, a surface region FCR facing the lens array 299 out of the surface of the photosensitive drum 21 (latent image carrier) has a curvature in the section along the sub scanning direction as shown in FIGS. 30 and 31. Accordingly, when distances between the respective focus positions FP1 to FP4 and the surface of the photosensitive drum 21 are defined as image-photosensitive member distances fd1 to fd4, there occurs a difference among the image-photosensitive member distances fd1 to fd4. In other words, the image-photosensitive member distance between the focus position FP and the photosensitive drum surface differ among the plurality of lens rows LSR1 to LSR4. Because of such a difference of the image-photosensitive member distance, images formed on the surface of the photosensitive drum 21 differ depending on the lens row LSR. As a result, there is a possibility of an occurrence of an exposure failure of being unable to perform a satisfactory exposure. Here, each of the image-photosensitive member distances fd1 to fd4 is a distance between the focus position FP and the photosensitive drum surface in the direction of the optical axis OA of the lens LS corresponding to the focus position FP.

Here, the above-described exposure failure is described using a more specific simulation result in order to facilitate the understanding of the invention. In other words, the specific content of the exposure failure is described through a simulation result on the relationship of arrangement of the photosensitive drum 21 and the line head 29 as shown in FIGS. 30 and 31 in the case where all the lenses LS have the same lens configuration and lens position.

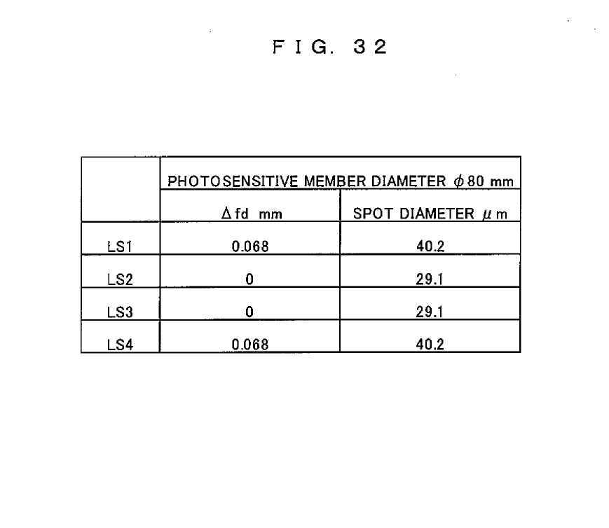

The lens data, the aspherical surface coefficients and the specification of an optical system used in the simulation of the comparative example 2 are given by above FIG. 17 to FIG. 19 and the equation (1) as in the working example 1. FIG. 32 shows a simulation result in the case where all the lenses LS1 to LS4 are formed based on the data given by above FIG. 17 to FIG. 19 and the equation (1). In this simulation, a lens row pitch Plsr and a light emitting element group row pitch Pegr are 1.65 mm, and a photosensitive drum diameter is 80 mm. Differences Δfd shown in FIG. 32 are differences between image-photosensitive member distances fd1 to fd4 corresponding to the lenses LS1 to LS4 and the image-photosensitive member distance fd2. In other words, the differences Δfd among the image-photosensitive member distances fd1 to fd4 are calculated based on the image-photosensitive member distance fd2.

There occurs a differences Δfd of 0.068 mm between the image-photosensitive member distance fd1 corresponding to the lens LS1 and the image-photosensitive member distance fd2 corresponding to the lens LS2. And, there occurs a differences Δfd of 0.068 mm between the image-photosensitive member distance fd4 corresponding to the lens LS4 and the image-photosensitive member distance fd2 corresponding to the lens LS2. Further, there is no difference Δfd between the image-photosensitive member distance fd3 corresponding to the lens LS3 and the image-photosensitive member distance fd2 corresponding to the lens LS2. Such a difference Δfd among the image-photosensitive member distances fd1 to fd4 results from the fact that the photosensitive drum 21 has a curvature in the section along the sub scanning direction as described above. As shown by spot diameters in FIG. 32 column, the diameters of the spots formed on the surface of the photosensitive drum 21 differ among the lenses LS1 to LS4 due to the differences among the image-photosensitive member distances fd1 to fd4. Specifically, the values of the diameters of the spots formed by the lenses LS2 and LS3 are 29.1 μm, whereas the values of the diameters of the spots formed by the lenses LS1 and LS4 are 40.2 μm. Accordingly, there is a difference of 11.1 μm (=40.2 μm−29.1 μm) between the diameter of the spots formed by the lens LS2 (or the lens LS3) and the diameters of the spots formed by the lens LS1 (or the lens LS4). In other words, there occurs an exposure failure that the diameters of the spots to be formed differ among the plurality of lens rows LSR1 to LSR4.

As described using the comparative example 2, the image-photosensitive member distances fd1 to fd4 differ because the photosensitive drum 21 has a curvature in the section along the sub scanning direction. As a result, there occurs differences in the diameters of the spots formed on the surface of the photosensitive drum 21. In the line head 29 used in the invention, a plurality of clear member CM are arranged corresponding to the plurality of lenses LS to cope with such a problem. Here, a description is made using a specific working example 2 in order to facilitate the understanding of the invention.

### Working Example 2

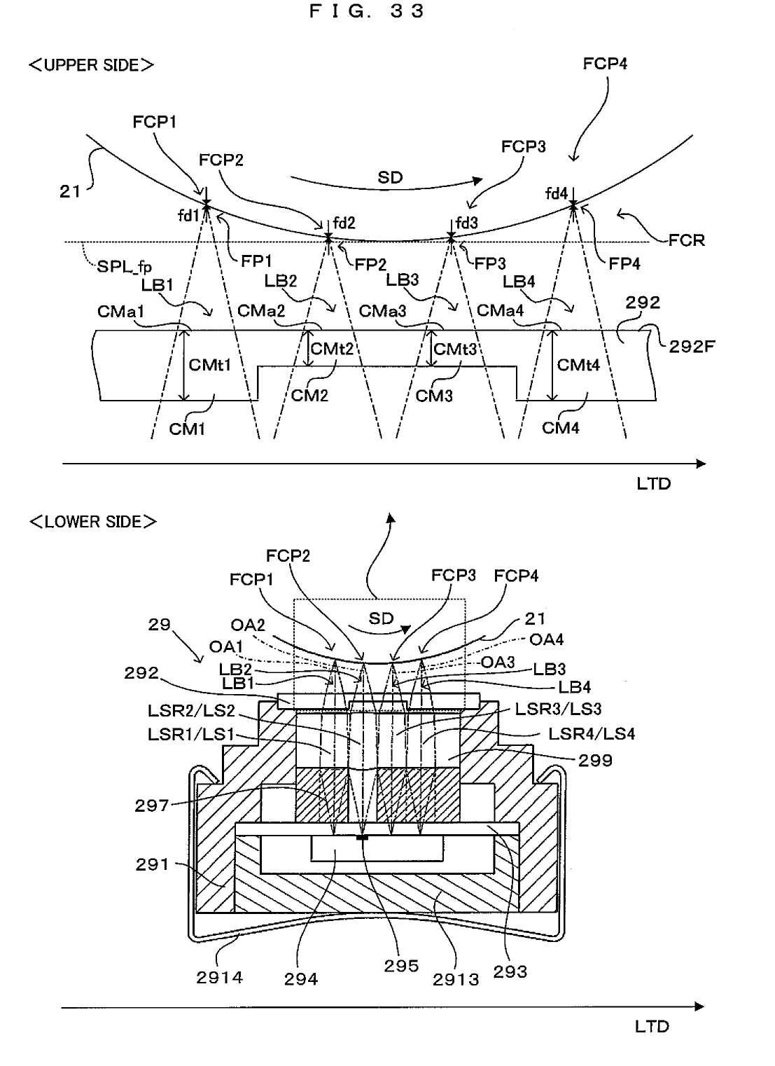

FIG. 33 is a sectional view along the sub scanning direction showing the relationship of arrangement of a line head and a photosensitive drum according to a working example 2 of the invention. An upper side of FIG. 31 enlargedly shows a rectangular part enclosed by broken line in a lower side of FIG. 31. Lenses LS1 to LS4 in the lower side of FIG. 31 are lenses belonging to mutually different lens rows LSR1 to LSR4.

In the working example 2, the relationship of arrangement of the lens array 299 and the photosensitive drum 21 is the same as in the comparative example 2. Specifically, as described with reference to FIG. 31, four lens rows LSR1 to LSR4 are arranged at lens row pitches Plsr in the width direction LTD and are substantially symmetrically arranged in the width direction LTD with respect to a symmetry axis SA. Further, the lens rows LSR1 to LSR4 are arranged such that optical axes OA1 to OA4 of the lenses LS1 to LS4 belonging to the lens rows LSR1 to LSR4 are parallel to each other. The lens array 299 is arranged such that the symmetry axis SA passes a curvature center CC21 of the photosensitive drum 21 (that is, rotation axis of the photosensitive drum 21).

In the working example 2, a plurality of clear members CM are arranged corresponding to the plurality of lenses LS. In other words, in the line head 29 in the working example 2, each of the plurality of clear members CM is arranged between the lens LS to which the clear member CM corresponds and the photosensitive drum surface (latent image carrier surface). Accordingly, each of the plurality of lenses LS focuses a light beam emitted from a light emitting element 2951 of a light emitting element group 295, to which the lens LS corresponds, toward the photosensitive drum surface the lens LS faces via a clear member CM to which the lens LS corresponds. Here, each of the plurality of clear members CM has a specified member thickness in the direction of the optical axis of the lens LS to which the clear member CM corresponds.

In other words, as shown in FIG. 33, a clear member CM1 is arranged corresponding to the lens LS1, a clear member CM2 is arranged corresponding to the lens LS2, a clear member CM3 is arranged corresponding to the lens LS3, and a clear member CM4 is arranged corresponding to the lens LS4. And the clear members CM1 to CM4 have member thicknesses CMt1 to CMt4, respectively. Further, as shown in FIG. 33, in the working example 2, the plurality of clear members CM1 to CM4 are integrally formed or joined with each other to constitute a single clear substrate 292. Furthermore, the plurality of clear members CM1 to CM4 are formed such that respective clear member surfaces CMa1 to CMa4 thereof which are surfaces of the photosensitive drum side are flush with each other.

The lens rows LSR1 to LSR4 are all arranged to face the surface of the photosensitive drum 21. At this time, the respective lens rows LSR1 to LSR4 face facing positions FCP1 to FCP4 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1 via the clear member CM1. The lens LS2 belonging to the lens row LSR2 focuses a light beam LB2 emitted from a light emitting element group 295, which the lens LS2 is facing, toward the facing position FCP2 via the clear member CM2. The lens LS3 belonging to the lens row LSR3 focuses a light beam LB3 emitted from a light emitting element group 295, which the lens LS3 is facing, toward the facing position FCP3 via the clear member CM3. The lens LS4 belonging to the lens row LSR4 focuses a light beam LB4 emitted from a light emitting element group 295, which the lens LS4 is facing, toward the facing position FCP4 via the clear member CM4. In other words, the focus positions of the light beams focused by the lenses LS belonging to the different lens rows LSR mutually differ in the sub scanning direction SD. Accordingly, there is a possibility that an exposure failure as shown in the comparative example 2 occurs.

On the contrary, in the working example 2 of the invention, the focus positions FP1 to FP4 of the light beams by the lenses LS1 to LS4 are set at positions in conformity with the curvature shape of the surface of the photosensitive drum 21 (FIG. 33). The member thicknesses CMt1 to CMt4 of the plurality of clear members are determined such that the focus positions FP1 to FP4 of the light beams LB1 to LB4 passing through the plurality of clear members CM1 to CM4 respectively are in conformity with the positions corresponding to the curvature shape of the photosensitive drum surface to conform the focus positions FP1 to FP4 to the curvature shape in this way. This construction is specifically as follows.

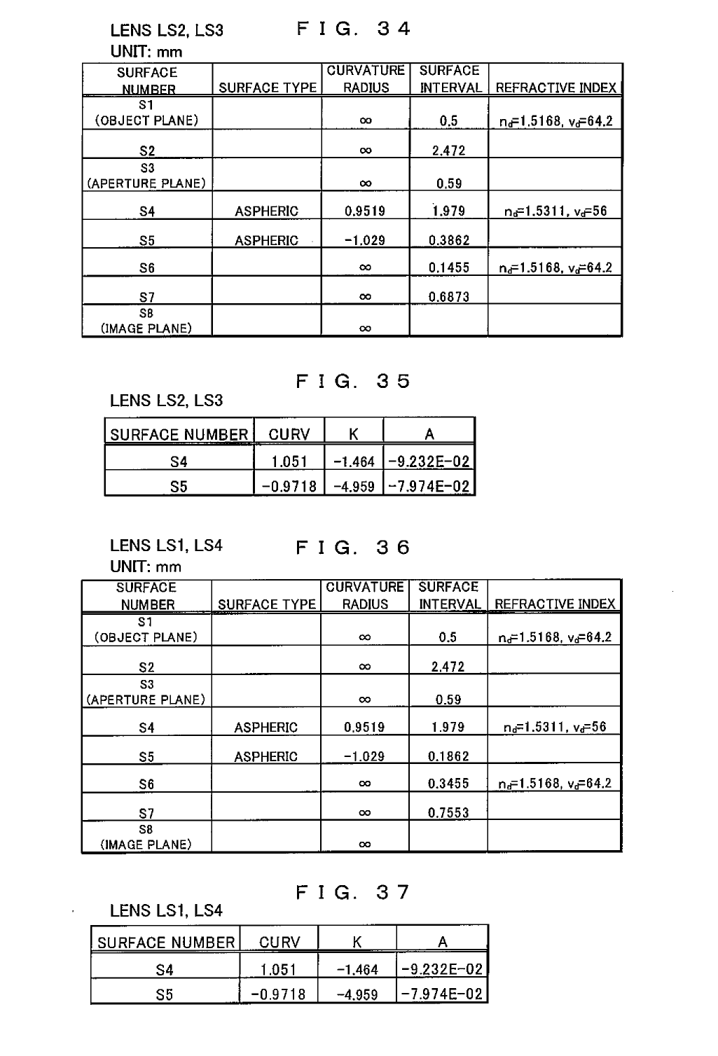

FIG. 34 shows the lens data of the lenses LS2, LS3, and FIG. 35 shows the aspherical surface coefficient of the lenses LS2, LS3. On the other hand, FIG. 36 shows the lens data of the lenses LS1, LS4, and FIG. 37 shows the aspherical surface coefficients of the lenses LS1, LS4. The surfaces corresponding to the respective surface numbers are the same as in the working example 1 (in other words, the same as that described with reference to FIG. 27). Accordingly, the surface interval of the surface number S6 gives the member thickness CMt of the clear member CM.

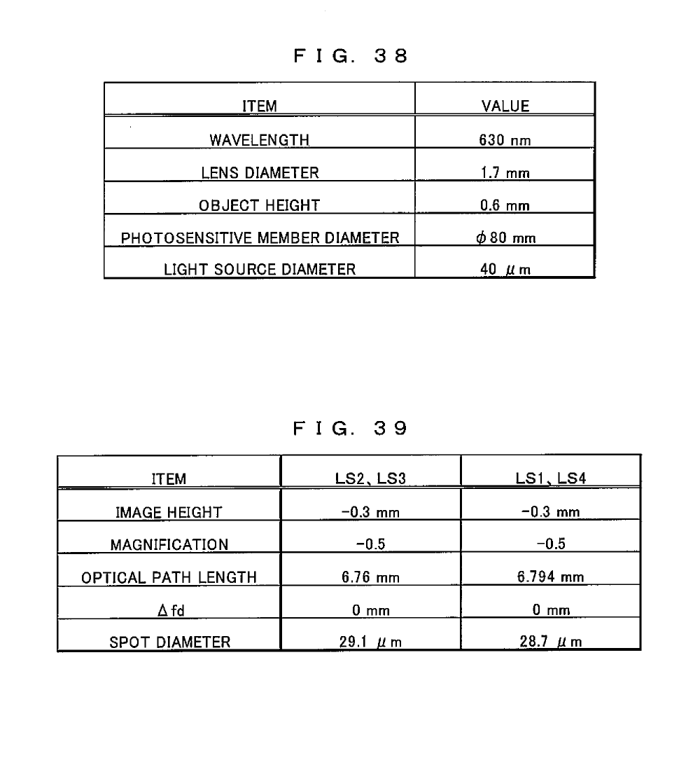

As can be understood from FIG. 34 to FIG. 37, the member thicknesses CMt of the corresponding clear members CM differ between the lenses LS2, LS3 and the lenses LS1, LS4 in the working example 2. Specifically, the member thicknesses CMt2, CMt3 of the clear members CM2, CM3 corresponding to the lenses LS2, LS3 are 0.1455 mm, whereas the member thicknesses CMt1, CMt4 of the clear members CM1, CM4 corresponding to the lenses LS1, LS4 are 0.3455 mm. All of the lenses LS1 to LS4 have the same lens configuration and lens position. FIG. 38 shows the specification of an optical system used in a simulation of the working example 2.

FIG. 39 shows a simulation result executed based on the data given by above FIG. 34 to FIG. 38. In this simulation, a lens row pitch Plsr, a light emitting element group row pitch Pegr, a photosensitive drum diameter and other conditions are the same as in the comparative example 2. Optical path lengths in FIG. 39 are those from the position of an object height of 0.6 mm to the positions of image heights of −0.3 mm corresponding to the respective lenses LS1 to LS4. Differences Δfd shown in FIG. 39 are differences between image-photosensitive member distances fd1 to fd4 corresponding to the lenses LS1 to LS4 and the image-photosensitive member distance fd2. In other words, the differences Δfd among the image-photosensitive member distances fd1 to fd4 are calculated based on the image-photosensitive member distance fd2. As shown in FIG. 39, the differences Δfd are 0 in the working example 2. In other words, the image-photosensitive member distances fd1 to fd4 are equal to each other. This is because the focus positions FP1 to FP4 of the light beams by the lenses LS1 to LS4 are set to the positions in conformity with the curvature shape of the photosensitive drum 21 (substantially on the surface of the photosensitive drum 21 as shown in FIG. 33 in the working example 2) as shown in FIG. 33. As shown in a column “Spot Diameter” of FIG. 39, it can be understood that differences in the diameters of spots formed on the surface of the photosensitive drum 21 are suppressed by suppressing the differences of the image-photosensitive member distances fd1 to fd4. Specifically, the diameter of the spots formed by the lenses LS2, LS3 are 29.1 μm, whereas the diameter of the spots formed by the lenses LS1, LS4 is 28.7 μm. Accordingly, a spot diameter difference in the working example 2 is 0.4 μm (=29.1 μm−28.7 μm) and an improvement as compared to the spot diameter difference of 11.1 μm in the comparative example 2 can be understood. In other words, an occurrence of an exposure failure that the diameters of the formed spots differ among a plurality of lens rows LSR1 to LSR4 is suppressed in the working example 2 as compared to the comparative example 2.

In this way, in the working example 2, the member thicknesses CMt1 to CMt4 of the plurality of clear members CM1 to CM4 are determined such that the focus positions FP1 to FP4 of the light beams LB1 to LB4 transmissive through the plurality of respective clear members CM1 to CM4 conform to the curvature shape of the photosensitive drum surface. Accordingly, an occurrence of such a problem that the distances (the image-photosensitive member distances fd) between the focus positions FP1 to FP4 and the photosensitive drum surface differ depending on the plurality of lens rows LSR1 to LSR4 as described above can be suppressed. As a result, a satisfactory exposure can be advantageously realized by the invention.

In the working example 2, the lens array 299 is constructed such that the respective lenses LS have the same lens configuration and are arranged at the same lens positions. In other words, in the working example 2, the construction of the lens array 299 is simplified. As a result, the construction of the line head is simple, and the cost reduction of the line head 29 is easy. In the working example 2, a “lens system” of the invention thus includes one lens LS.

In the working example 2, the second surface LSFs (LSFs1 to LSFs4) of the lenses LS is opposed to the photosensitive drum surface. And the clear substrate 292, which is optically transmissive, is arranged between the second surface LSFs (lens surface) of the lenses LS and the photosensitive drum surface. The clear substrate 292 has an opposed surface 292F opposed to the photosensitive drum surface, and the opposed surface 292F is a continuous surface without a concavo-convex shape. Accordingly, toner scattered from the photosensitive drum surface toward the lens array 299 reaches the clear substrate 292 before reaching the lens array 299. Furthermore, the opposed surface 292F of the clear substrate 292 is a continuous surface without a concavo-convex shape, which is hard for the scattered-toner to adhere and accumulate. Hence, in the working example 2, an occurrence of the problem that a light quantity of the light beam contributing to the exposure of the photosensitive drum surface decreases due to the scattered-toner is suppressed, and it is possible to execute an excellent exposure.

Further, in the working example 2, the opposed surface 292F of the clear substrate 292 is flat, which is advantageous in suppressing an adhesion and an accumulation of the scattered-toner. In other words, the opposed surface 292F of the working example 2 has a shape hard for the scattered-toner to adhere and accumulate as compared to the case where the opposed surface is concave for instance, which is preferable.

### Working Example 3

Incidentally, in the working examples 1 and 2, the focus positions FP are set by determining the member thickness of the clear substrate 292. However, the focus positions FP can also be set by determining the lens number, the lens configurations, and the lens positions of the lenses LS. Consequently, the focus positions FP are set by using a plurality of lenses LS and determining the lens configurations of these lenses LS in the working example 3.

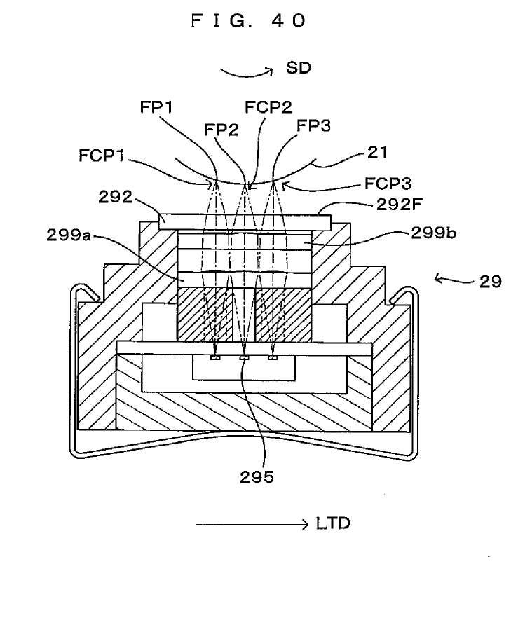

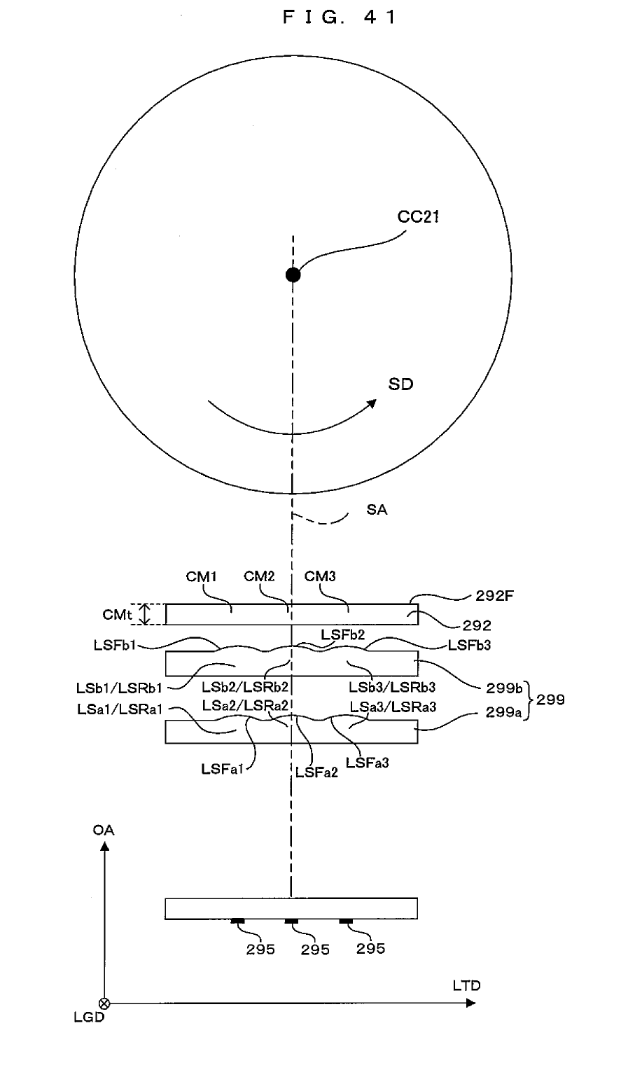

FIG. 40 is a partial sectional view along the width direction showing a construction of a line head in a working example 3, and FIG. 41 is a diagram showing a construction of an optical system of the line head in the working example 3. Also in the working example 3, three light emitting element groups 295 are arranged at mutually different positions in the width direction LTD. Since the construction of each of the light emitting element groups 295 is similar, the construction of the light emitting element group 295 on the extreme left in FIG. 41 is described here. The same construction of the other light emitting element groups 295 are identified by the equivalent reference numerals and is not described. In the working example 3, two lenses LS, that is, a first lens LSa1 and a second lens LSb1 are arranged side by side in the direction of the optical axis OA with respect to one light emitting element group 295. The first lens LSa1 includes a lens surface LSFa1 having a lens curvature which faces the second lens LSb1. The second lens LSb1 includes a lens surface LSFb1 having a lens curvature which faces the photosensitive drum 21. The clear member CM1 is arranged between the lens surface LSFb1 and the photosensitive drum 21. Accordingly, the light beams emitted from the light emitting element groups 295 expose the surface of the photosensitive drum 21 via the first lens LSa1, the second lens LSb1 and the clear member CM1. In the working example 3, a “lens system” of the invention thus includes two lenses LS, that is, the first lens LSa1 and the second lens LSb1.

Also in the working example 3, a plurality of light emitting element groups 295 are aligned in the direction orthogonal to a plane of FIG. 41 (that is, in the longitudinal direction LGD) to constitute the light emitting element group row 295R as described above. The first lens LSa1 and the second lens LSb1 also constitute a first lens row LSRa1 and a second lens row LSRb1 corresponding to such a light emitting element group row 295R, respectively. In other words, a plurality of first lenses LSa1 aligned in the longitudinal direction LGD constitute the first lens row LSRa1, and a plurality of second lenses LSb1 aligned in the longitudinal direction LGD constitute the second lens row LSRb1.

Three light emitting element group rows 295R are arranged in the width direction LTD. Corresponding to this, three first lens rows LSRa1 to LSRa3 are arranged in the width direction LTD, and three second lens rows LSRb1 to LSRb3 are arranged in the width direction LTD. The three lens rows arranged in the width direction LTD are arranged at equally-spaced intervals and are symmetrically arranged in the width direction LTD with respect to a symmetry axis SA. The symmetry axis SA passes a curvature center CC21 of the photosensitive drum 21. The three first lens rows LSRa1 to LSRa3 are integrally formed or joined with each other to constitute a first lens array 299a. In the same way, the three second lens rows LSRb1 to LSRb3 are integrally formed or joined with each other to constitute a second lens array 299b. The first lens array 299a and the second lens array 299b function as one lens array 299.

In the working example 3, the clear members CM1 to CM3 have the same member thickness CMt. Further, the plurality of clear members CM1 to CM3 are formed integrally to constitute a clear substrate 292. Furthermore, the plurality of clear members CM1 to CM3 are formed such that respective clear member surfaces CMa1 to CMa3 thereof which are surfaces of the photosensitive drum side are flush with each other. In other words, the clear substrate 292 is in a shape of a flat plate having a uniform member thickness CMt.

Also in the working example 3, the lens rows LSR1 to LSR3 are all arranged to face the surface of the photosensitive drum 21. The respective lens rows LSR1 to LSR3 face facing positions FCP1 to FCP3 of the photosensitive drum surface mutually different in the sub scanning direction SD. Accordingly, the lens LS1 belonging to the lens row LSR1 focuses a light beam LB1 emitted from a light emitting element group 295, which the lens LS1 is facing, toward the facing position FCP1 via the clear member CM1. The lens LS2 belonging to the lens row LSR2 focuses a light beam LB2 emitted from a light emitting element group 295, which the lens LS2 is facing, toward the facing position FCP2 via the clear member CM2. The lens LS3 belonging to the lens row LSR3 focuses a light beam LB3 emitted from a light emitting element group 295, which the lens LS3 is facing, toward the facing position FCP3 via the clear member CM3. In other words, the focus positions of the light beams focused by the lenses LS belonging to the different lens rows LSR mutually differ in the sub scanning direction SD. Accordingly, there is a possibility that an exposure failure as shown in the comparative example 1 occurs.

On the contrary, in the working example 3 of the invention, the focus positions FP1 to FP3 of the light beams by the lenses LS1 to LS3 are set at positions in conformity with the curvature shape of the surface of the photosensitive drum 21 (FIG. 40). The configuration of the plurality of lenses LS1 to LS3 are determined to conform the focus positions FP1 to FP3 to the curvature shape in this way. This construction is specifically as follows.

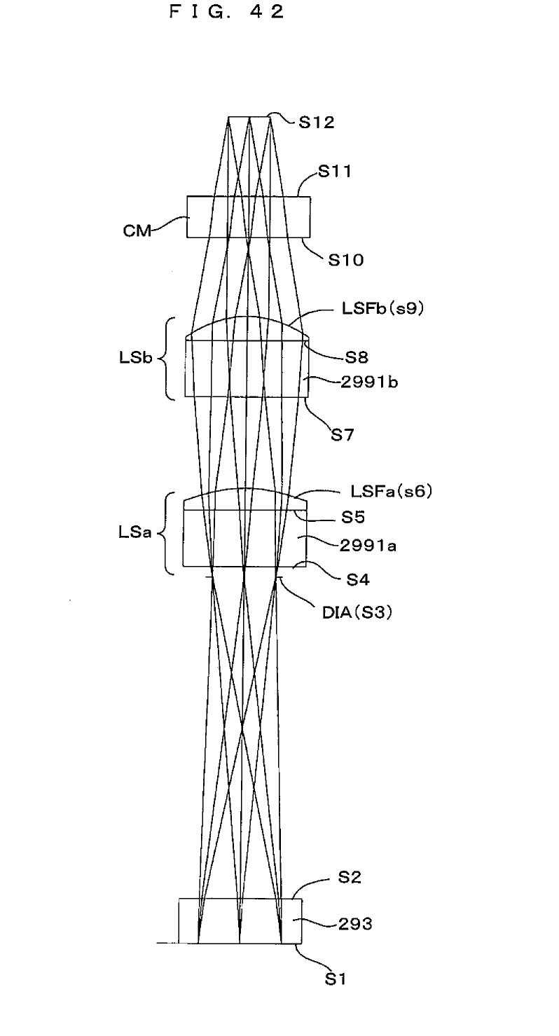

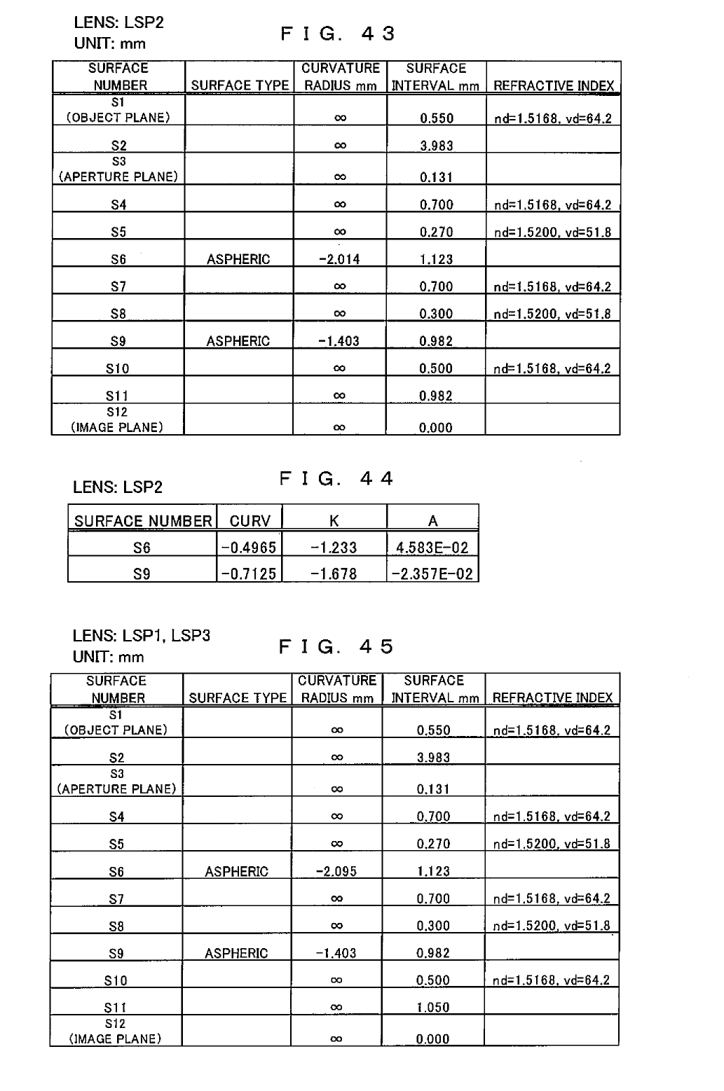

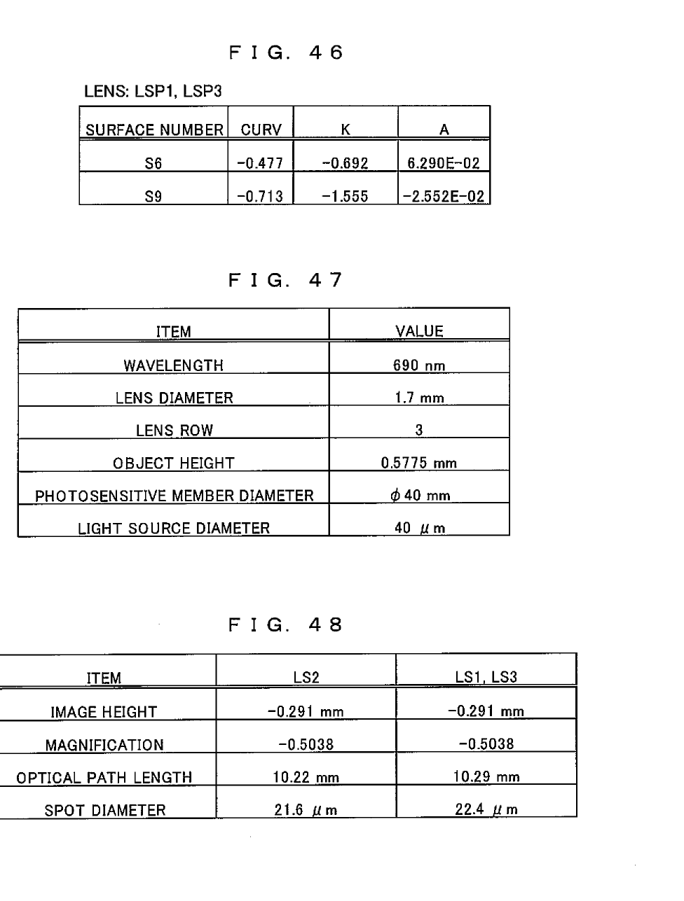

FIG. 42 is a diagram describing surface numbers and surfaces corresponding thereto. FIG. 43 shows the lens data of the lenses LSa2, LSb2, and FIG. 44 shows the aspherical surface coefficient of the lenses LSa2, LSb2. On the other hand, FIG. 45 shows the lens data of the lenses LSa1, LSb1, LSa3, LSb3, and FIG. 46 shows the aspherical surface coefficients of the lenses LSa1, LSb1, LSa3, LSb3. In this working example 3, a lens pair consisting of the lenses LSa1, LSb1 is referred to as a lens pair LSP1, a lens pair consisting of the lenses LSa2, LSb2 is referred to as a lens pair LSP2, and a lens pair consisting of the lenses LSa3, LSb3 is referred to as a lens pair LSP3.

The surface number S1 corresponds to an object plane, that is, the under surface of the head substrate 293 where the light emitting elements 2951 are arranged. The surface number S2 corresponds to the top surface of the head substrate 293. The surface number S3 corresponds to a plane where the aperture diaphragm DIA is arranged (aperture plane). The aperture diaphragm DIA is arranged at the front focus of an optical system comprised of the first lens LSa and the second lens LSb to realize an image side telecentric system. The surface number S4 corresponds to an incidence surface of a first lens substrate 2991a. The surface number S5 corresponds to an emergence surface of the first lens substrate 2991a. The surface number S6 corresponds to a lens surface LSFa of the first lens LSa. The first lens LSa is thus comprised of the first lens substrate 2991a and the lens surface LSFa formed on the emergence surface of the substrate. The surface number S7 corresponds to an incidence surface of a second lens substrate 2991b. The surface number S8 corresponds to an emergence surface of the second lens substrate 2991b. The surface number S9 corresponds to a lens surface LSFb of the second lens LSb. The second lens LSb is thus comprised of the second lens substrate 2991b and the lens surface LSFb formed on the emergence surface of the substrate. The surface number 510 corresponds to the under surface of the clear member CM (in other words, clear member surface of the lens side). The surface number S11 corresponds to the top surface of the clear member CM (in other words, clear member surface of the latent image carrier side). Accordingly, the surface interval of the surface number S10 gives the member thickness CMt of the clear member CM. Further, the surface number S12 corresponds to the image plane IP, that is, the surface of the photosensitive drum (latent image carrier). As can be understood from FIG. 43 to FIG. 46, the shapes (curvature) of the lens surfaces LSFa, LSFb differ between the lens pair LSP2 and the lens pairs LSP1, LSP3 in the working example 3. FIG. 47 shows the specification of an optical system used in a simulation of the working example 3.

FIG. 48 shows a simulation result executed based on the data given by above FIG. 43 to FIG. 47. Optical path lengths in FIG. 47 are those from the position of an object height of 0.5775 mm to the positions of image heights of −0.291 mm corresponding to the respective lenses. As shown in a column “Spot Diameter” of FIG. 47, it can be understood that differences in the diameters of spots formed on the surface of the photosensitive drum 21 are suppressed. Specifically, the diameter of the spots formed by the lens pair LSP2 is 21.6 μm, whereas the diameter of the spots formed by the lens pairs LSP1, LSP3 is 22.4 μm. Accordingly, a spot diameter difference in the working example 3 is 0.8 μm (=22.4 μM−21.6 μm) and an improvement as compared to the spot diameter difference of 3.2 μm in the comparative example 1 can be understood. In other words, an occurrence of an exposure failure that the diameters of the formed spots differ among a plurality of lens rows is suppressed in the working example 3 as compared to the comparative example 1.

In this way, in the working example 3, the configuration of the lenses LS are determined such that the focus positions FP1 to FP3 of the light beams LB1 to LB3 conform to the curvature shape of the photosensitive drum surface. As a result, a satisfactory exposure can be advantageously realized.

Further, in the working example 3, a plurality (two) of lenses LS are provided with respect to one light emitting element group 295. In other words, a “lens system” of the invention includes a plurality of lenses LS in the working example 3. Hence, the freedom of optical design is increased as compared to the case where a single lens is used. As a result, it becomes possible to easily set the focus positions of light beams in the working example 3, which is preferable.

In the working example 3, the clear substrate 292 which is optically transmissive is in a shape of a flat plate having a uniform member thickness CMt. In the working example 3, the construction of the clear substrate 292 is simplified in this way, and hence, the construction of the line head 29 is simple, and the cost reduction of the line head 29 is easy.

In the working example 3, the second surface LSFs (LSFs1 to LSFs3) of the lenses LS is opposed to the photosensitive drum surface. And the clear substrate 292 is arranged between the second surface LSFs (lens surface) of the lenses LS and the photosensitive drum surface. The opposed surface 292F opposed to the photosensitive drum surface of the clear substrate 292 is a continuous surface without a concavo-convex shape.

Accordingly, toner scattered from the photosensitive drum surface toward the lens array 299 reaches the clear substrate 292 before reaching the lens array 299. Furthermore, the opposed surface 292F of the clear substrate 292 is a continuous surface without a concavo-convex shape, which is hard for the scattered-toner to adhere and accumulate. Hence, in the working example 3, an occurrence of the problem that a light quantity of the light beam contributing to the exposure of the photosensitive drum surface decreases due to the scattered-toner is suppressed, and it is possible to execute an excellent exposure.

Further, in the working example 3, the opposed surface 292F of the clear substrate 292 is flat, which is advantageous in suppressing an adhesion and an accumulation of the scattered-toner. In other words, the opposed surface 292F of the working example 3 has a shape hard for the scattered-toner to adhere and accumulate as compared to the case where the opposed surface is concave for instance, which is preferable.

By the way, it is desirable to suppress not only adherence and accumulation of scattered-toner to and on the lens array but adherence and accumulation of scattered-toner to and on the light emitting elements as well. With respect to this, the light emitting elements 2951 are bottom-emission type organic EL devices in the embodiment described above. Therefore, the light emitting elements 2951 are provided on the under surface of the head substrate 293, and this under surface is a surface opposite to the photosensitive drum out of two surfaces of the head substrate 293. Accordingly, a possibility that scattered-toner will adhere to the light emitting elements 2951 is suppressed, and hence, the above embodiment is preferable.

Further, in the above embodiment, the light shielding member 297 guides the light beams from the light emitting element group 295 to the lens LS corresponding to the light emitting element group 295, and prevents incidence of the light beams from the light emitting element group 295 upon the lenses LS which do not correspond to the light emitting element group 295, and the light shielding member 297 functions as an “enclosure member” of the invention. That is, the light guide holes 2971 are provided in the light shielding member 297 corresponding to transmitting areas of the light beams emitted from the light emitting elements 2951. In other words, the passing regions are enclosed by the light shielding member 297. The light shielding member 297 thus discourages occurrence of the problem that scattered-toner adheres to and accumulates on the passing regions of the light beams emitted from the light emitting elements. That is, in the above embodiment, the light shielding member 297 has a function of suppressing accumulation of toner in the passing regions of the light beams, in addition to its original function as a light shielding member. As a result, the structure of the line head is simplified.

Further, in the above embodiment, the case 291 seals the region from the clear substrate 292 to the plurality of light emitting elements 2951. Hence, a possibility of the scattered-toner slipping into a space between the clear substrate 292 and the light emitting elements 2951 is extremely low, and the above embodiment is preferable.

Further, the image forming apparatus in the above embodiment uses the developer 25 which develops with charged toner. It is preferable to apply the invention described above to such an apparatus to suppress accumulation of scattered-toner. This is because the problem of toner accumulation could be more serious since charged toner tends to adhere to and accumulate on the lens array 299.

In the above embodiment, the lenses LS are two-dimensionally arranged. As a result, the scattered-toner tends to accumulate more easily in this structure as compared to the structure in which the lenses are one-dimensionally arranged. In light of this, it is preferable to apply the invention to such a structure in which the lenses are two-dimensionally arranged for suppression of accumulation of the scattered-toner.

As described above, in the above embodiment, the main scanning direction MD corresponds to a “first direction” of the invention and the sub scanning direction SD to a “second direction” of the invention. Further, the clear substrate 292 corresponds to a “cover member” of the invention. Further, the photosensitive drum 21 corresponds to a “latent image carrier” of the invention and the surface of the photosensitive drum 21 to an “image plane” of the invention.

Example of a Method for Calculating a Focus Position

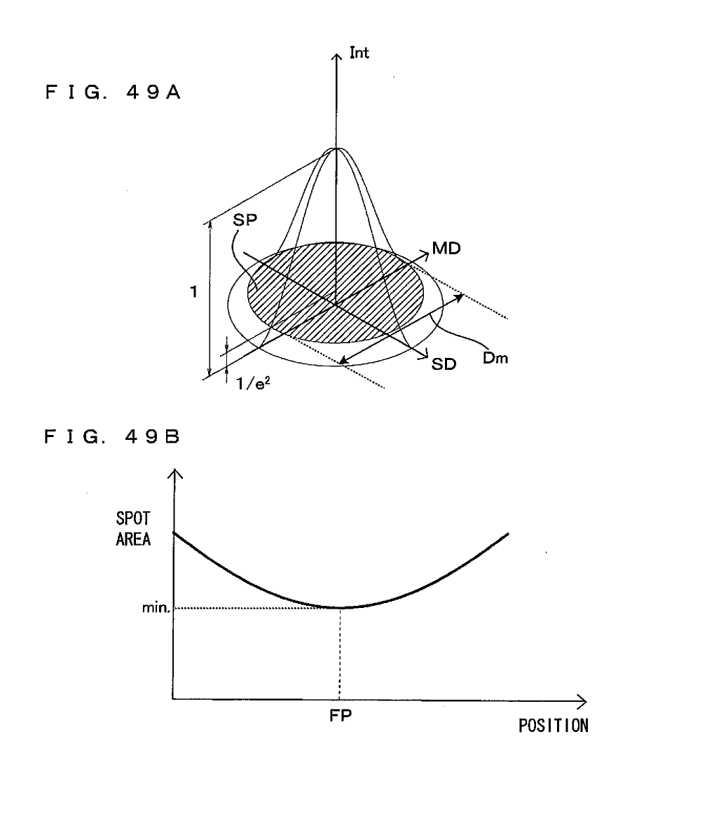

The focus position FP is described above to be the position and its vicinity where the light beam LB having passed through the lens LS forms an image with the smallest spot diameter. Here, an example of a method for calculating this focus position is introduced. FIGS. 49A and 49B are graphs showing the example of the method for calculating the focus position. In this example, the focus position is calculated from an area of a spot SP, which is defined as shown in FIG. 49A. Specifically, when the height of a peak of a light intensity Int of a light beam is assumed to be “1”, an area where the light intensity Int is “1/e²” is the spot SP. Here, “e” is the base of natural logarithm. A position where the area of the spot SP has a minimum value min can be calculated as the focus position FP.

Alternatively, the focus position FP may be calculated as follows. Specifically, the position where the area of the spot SP is minimized is calculated as the focus position FP in the above method, whereas a position where a spot diameter Dm of the spot SP in the main scanning direction MD is minimized may be calculated as the focus position FP.

Others

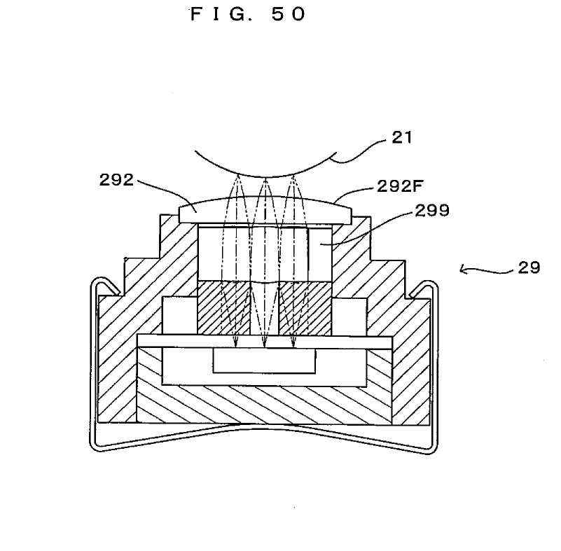

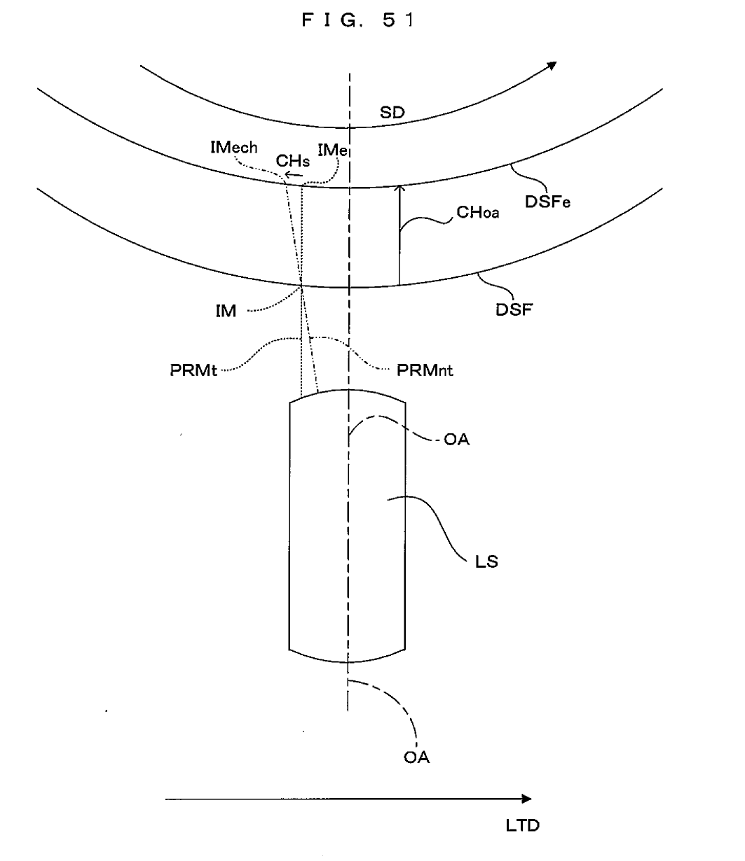

The invention is not limited to the above embodiments and various changes other than those described above can be made to such an extent as not to depart from the gist of the invention. For example, although the opposed surface 292F of the clear substrate 292 is a flat surface in the above working examples 1 to 3, the following structure may be used instead. FIG. 50 is a diagram showing other shape of the opposed surface of the clear substrate. In FIG. 50, the opposed surface 292F of the clear substrate 292 is convex relative to the surface of the photosensitive drum 21. The other structure is similar to those in the above working examples 1 to 3 and therefore will not be described. Such a shape of the opposed surface 292F is advantageous to suppression of adherence and accumulation of scattered-toner. That is, the opposed surface 292F shown in FIG. 50 has a shape hard for the scattered-toner to adhere and accumulate as compared to the case where the opposed surface is concave for instance, which is preferable.

In the working examples 1 to 3 for example, the line head 29 is arranged relative to the photosensitive drum 21 as described with reference to FIGS. 16, 31 and 41. Specifically, the line head 29 is arranged relative to the photosensitive drum 21 such that the symmetry axis SA of a plurality of lens rows LSR arranged side by side in the width direction LTD passes the curvature center CC21 of the photosensitive drum 21. However, the arrangement mode of the line head 29 relative to the photosensitive drum 21 is not limited to this. In short, the line head 29 may be arranged relative to the photosensitive drum 21 such that the symmetry axis SA passes a position deviated from the curvature center CC21 of the photosensitive drum 21.

As described with reference to FIGS. 9 and 10, the aperture diaphragm DIA is disposed at the front focus of the lens LS and the image side of the lens LS is constructed to be telecentric in the above embodiment. However, it is not essential to the invention to telecentrically construct the image side of the lens LS. However, there are cases where the distance between the lens LS and the photosensitive drum surface changes due to the decentering of the photosensitive drum 21 and the like. Such a change might possibly induce displacements of the positions of the spots formed on the photosensitive drum surface in the sub scanning direction SD. On the other hand, the telecentrically constructed lens LS is preferable because an effect of suppressing such displacements of the spot positions in the sub scanning direction SD can be fulfilled and a satisfactory exposure can be realized. This is described in detail.

FIG. 51 is a sectional view along the sub scanning direction showing an effect in the case where an image side of a lens is constructed to be telecentric. A surface DSF represents the surface of the photosensitive drum 21 with no decentering. A surface DSFe is a surface of the photosensitive drum 21 displaced by a distance CHoa in a direction of an optical axis OA of a lens LS due to the decentering of the photosensitive drum 21. A chief ray PRMt is that of a light beam for forming a spot at a position IM on the photosensitive drum surface in the case where an image-side telecentric system is realized. On the other hand, a chief ray PRMnt is that of a light beam for forming a spot at the position IN on the photosensitive drum surface in the case where the image-side telecentric system is not realized. In other words, the positions of the chief rays PRMt and PRMnt on the surface of the photosensitive drum 21 are the same when the photosensitive drum 21 is not decentered.

Here is thought a case where the surface of the photosensitive drum 21 is displaced by the distance CHoa in the direction of the optical axis OA of the lens LS due to the decentering of the photosensitive drum 21. At this time, a spot is formed at a position IMe by the light beam having the chief ray PRMt. On the other hand, a spot is formed at a position IMech by the light beam having the chief ray PRMnt. As shown in FIG. 51, when the image-side telecentric system is realized, the chief ray PRMt of the light beam is parallel to the optical axis OA of the lens LS. Accordingly, even if the surface of the photosensitive drum 21 is displaced in the direction of the optical axis OA, the position of the spot to be formed is only displaced in the direction of the optical axis OA, but hardly displaced in the sub scanning direction SD. On the other hand, when the image-side telecentric system is not realized, the chief ray PRMnt of the light beam is not parallel to the optical axis OA of the lens LS. Accordingly, if the surface of the photosensitive drum 21 is displaced in the direction of the optical axis OA, the position of the spot to be formed is displaced by a distance CHs in the sub scanning direction SD. Thus, the telecentrically constructed lens LS is preferable because an effect of suppressing such a displacement of the spot position in the sub scanning direction SD can be fulfilled and a satisfactory exposure can be realized.

In the above embodiment, the photosensitive drum 21 is used as the latent image carrier. However, the latent image carrier, to which the invention is applicable, is not limited to the photosensitive drum 21. In short, the invention is applicable to latent image carriers in general whose surface area facing the lens array 299 has a curvature in the section along the sub scanning direction.

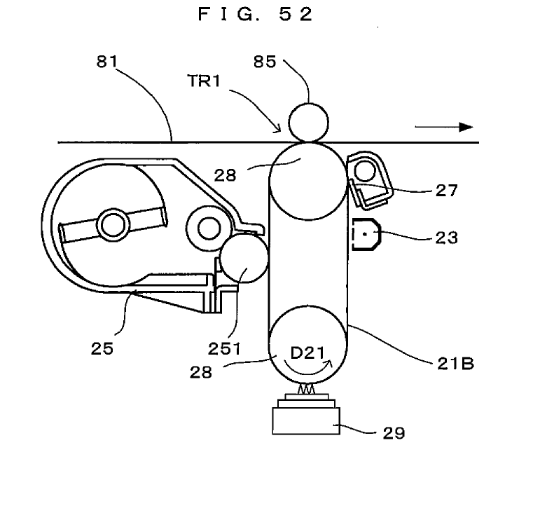

FIG. 52 is a sectional view along the sub scanning direction showing an image forming apparatus including the line head according to the invention. This embodiment largely differs from the embodiment of FIG. 1 in the mode of the photosensitive member. Specifically, in this embodiment, a photosensitive belt 21B is used instead of the photosensitive drum 21. Since the other construction is the same as in the above embodiment, the same construction is identified by the same or equivalent reference numerals and is not described.

In this embodiment, the photosensitive belt 21B is mounted on two rollers 28 extending in the main scanning direction MD. This photosensitive belt 21B is turned in a specified direction of rotation D21 by an unillustrated drive motor. A charger 23, a line head 29, a developing device 25 and a photosensitive member cleaner 27 are arranged along the direction of rotation D21 around this photosensitive belt 21B. A charging operation, a latent image forming operation and a toner developing operation are performed by these functional devices.

In this embodiment, the line head 29 is arranged to face a part of the photosensitive belt 21B mounted on the roller 28. The rollers 28 are cylindrical. Accordingly, the mounted part of the photosensitive belt 21B has a curvature shape. The line head 29 is arranged to face the mounted part for the following reason. Specifically, stretching surfaces of the photosensitive belt 21B flips relatively more than the mounted parts thereof on the rollers 28. Thus, by arranging the line head 29 to face the mounted part on the roller 28, which flips relatively less, out of the surface of the photosensitive belt 21B, the distance between the line head 29 and the photosensitive belt 21B can be stabilized.

However, the surface shape of the photosensitive belt 21B in the mounted part on the roller 28 has a curvature in the section along the sub scanning direction. Accordingly, there is a possibility of an occurrence of such an exposure failure as described above. Thus, in an image forming apparatus constructed as in FIG. 52, a satisfactory exposure can be advantageously realized by applying the invention to set the focus positions of the light beams to those in conformity with the curvature shape of the surface of the photosensitive belt 21B.

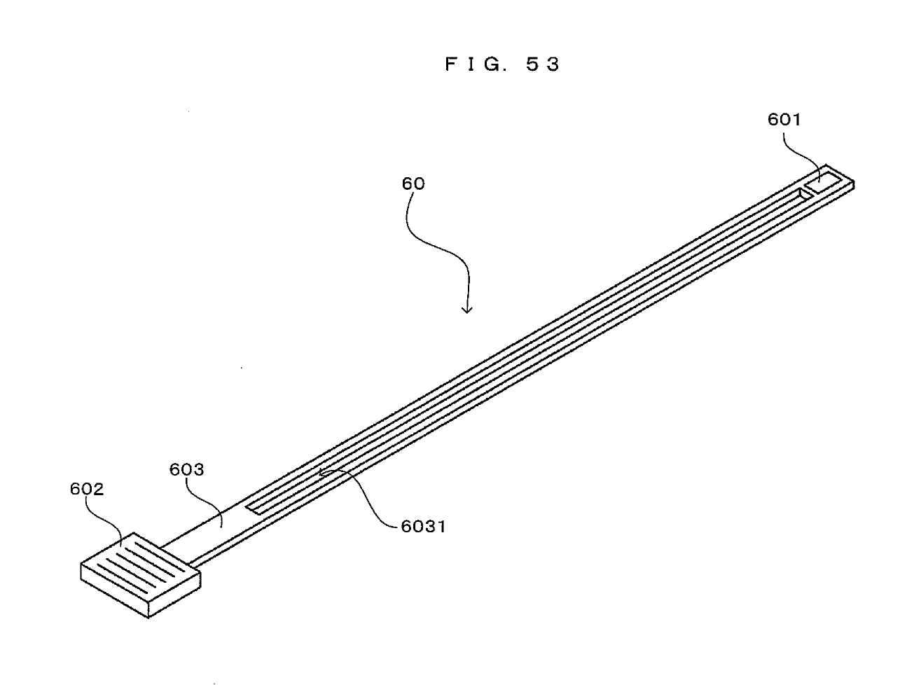

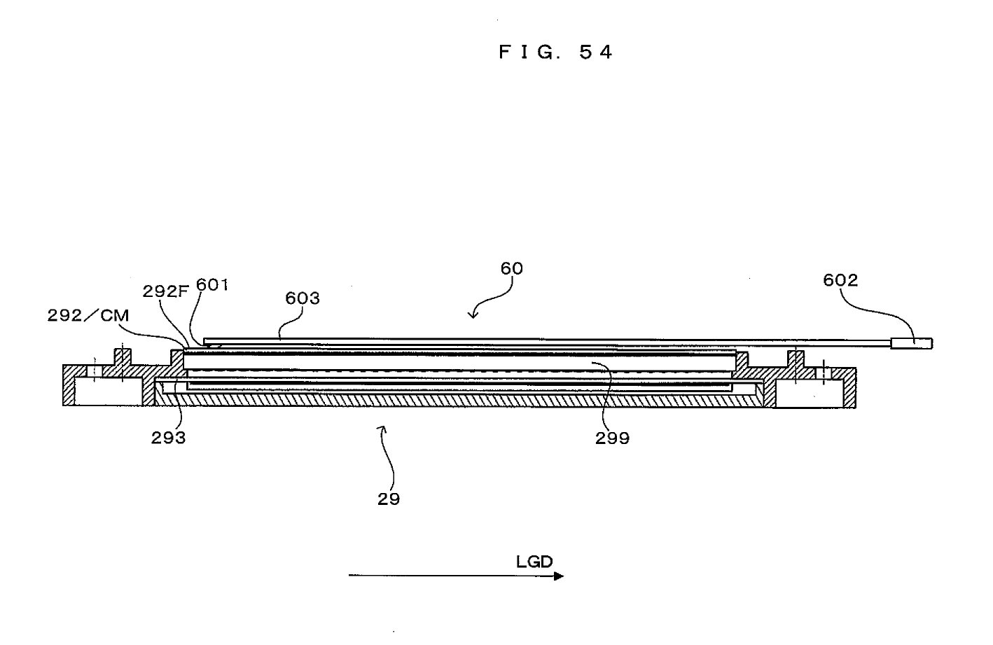

Further, a cleaner as described below may be disposed. FIG. 53 is a perspective view of a cleaner. A cleaner 60 cleans clear member surfaces of the photosensitive drum side of the plurality of clear members CM. Specifically, the cleaner includes a cleaning pad 601 and a handle 602. The material of the cleaning pad 601 is a synthetic leather. Here, the synthetic leather may be Ecsaine (registered trademark) manufactured by Toray Industries, Inc. The cleaning pad 601 and the handle 602 are connected by a connector member 603. An elongate hole 6031 is perforated in the connector member 603.

FIG. 54 is a diagram showing a cleaning operation performed by the cleaner. As shown in FIG. 54, the cleaner 60 is disposed relative to the line head 29 such that the direction in which the connector member 603 extends is parallel to the longitudinal direction LGD. The cleaning pad 601 is in contact with the clear substrate 292, that is, the clear member surfaces (photosensitive-member-side clear member surfaces) of the photosensitive drum side (the latent image carrier side) of the clear members CM. When an operator moves the handle 602 in the longitudinal direction LGD, the cleaning pad 601 moves in the longitudinal direction LGD while remaining in contact with the photosensitive-member-side clear member surfaces (the opposed surface 292F). Accordingly, the cleaning pad 601 scrapes off and removes scattered-toner adhering to the photosensitive-member-side clear member surfaces.

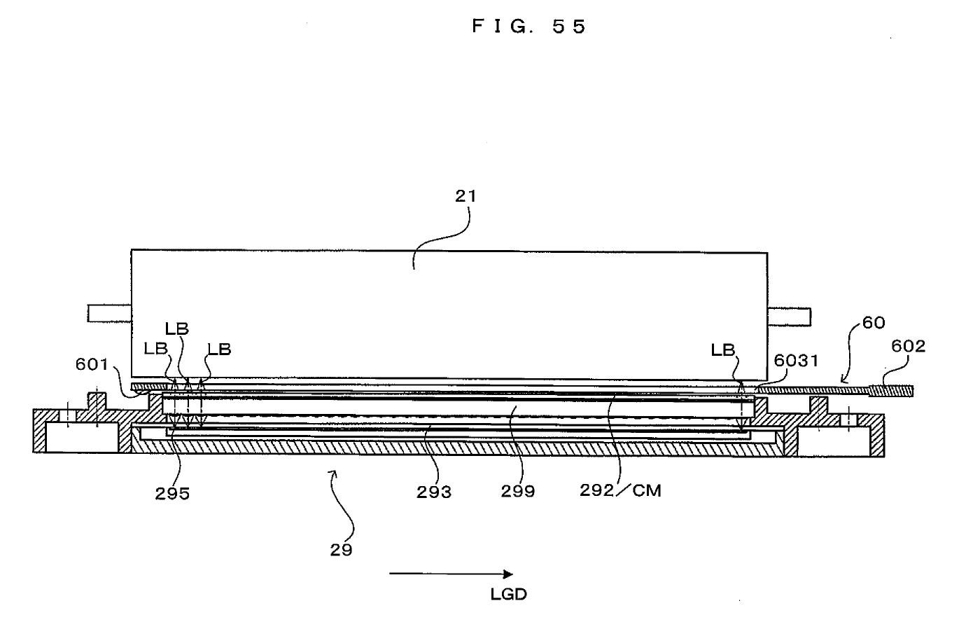

FIG. 55 is a cross sectional view showing a location of the cleaner during the latent image forming operation. Of the cleaner 60, a portion which is not hatched is the elongate hole 6031 while hatched portions are the parts other than the elongate hole 6031 (the cleaning pad 601, the handle 602 and the part of the connector member 603 other than the elongate hole 6031). In this way, during the latent image forming operation, the cleaner 60 is arranged relative to the line head 29 so that the elongate hole 6031 is opposed to the clear members CM (the clear substrate 292). Therefore, the light beams LB emitted from the light emitting element groups 295 expose the surface of the photosensitive drum 21 without being blocked by the cleaner 60.

As described above, in this modification, the cleaner 60 is further provided which cleans the clear member surfaces of the photosensitive drum side (the latent image carrier side) of the plurality of clear members CM. Hence, even when the scattered-toner has adhered to the clear member surfaces (the opposed surface 292F) of the photosensitive drum side of the clear members CM, it is possible to remove the toner adhering to the clear member surfaces by means of the cleaner 60, which is preferable.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A line head, comprising:
a substrate on which a plurality of light emitting elements are provided;
a lens array that includes a plurality of lenses; and
a cover member that is optically transmissive, is opposed to the lens array, and is provided at the other side of the substrate with respect to the lens array.

2. The line head of claim 1, wherein the cover member includes an opposed surface that is opposed to a latent image-forming surface and is a flat surface.

3. The line head of claim 1, wherein the cover member includes an opposed surface that is opposed to a latent image-forming surface and is convex relative to the latent image-forming surface.

4. The line head of claim 1, wherein the lens array includes a surface that is opposed to a latent image-forming surface and is in a substantially concavo-convex shape.

5. The line head of claim 1, comprising an enclosure member that encloses a transmitting area of the light beams emitted from the plurality of light emitting elements and is provided between the plurality of light emitting elements and the lens array.

6. The line head of claim 5, wherein the enclosure member is a light shielding member that guides the light beams from the plurality of light emitting elements to the lens system corresponding to the plurality of light emitting elements, and prevents incidence of the light beams from the plurality of light emitting elements upon the lens system which does not correspond to the plurality of light emitting elements.

7. The line head of claim 1, comprising a case that seals a region from the cover member to the plurality of light emitting elements.

8. The line head of claim 1, comprising a cleaner, wherein
the cover member includes an opposed surface that is opposed to a latent image-forming surface, and
the cleaner cleans the opposed surface of the cover member.

9. The line head of claim 1, wherein
the cover member is opposed to a latent image-forming surface,
the latent image-forming surface is transported in a second direction which is orthogonal to or substantially orthogonal to a first direction, and
the lens array includes a plurality of lens rows, each of which is comprised of the plurality of lenses aligned in a direction corresponding to the first direction, that are arranged at mutually different positions in a direction corresponding to the second direction.

10. The line head of claim 9, wherein
an area in the latent image-forming surface which is opposed to the lens array has a curvature in a section along the second direction, and
focus positions of the light beams emitted from the plurality of light emitting elements are set in accordance with a curvature shape of the latent image-forming surface.

11. The line head of claim 10, wherein lens configurations and/or lens positions relative to the plurality of light emitting elements of the plurality of lenses are determined such that focus positions of the light beams by the plurality of lenses conform to the curvature shape of the latent image-forming surface.

12. The line head of claim 11, wherein
the plurality of luminous elements are grouped into luminous element groups, and
a plurality of lenses are provided with respect to one luminous element group in the lens array.

13. The line head of claim 11, wherein the cover member is in a shape of a flat plate having a uniform member thickness.

14. The line head of claim 10, wherein the member thickness of the cover member is determined such that focus positions of the light beams transmitting the cover member conform to the curvature shape of the latent image-forming surface.

15. The line head of claim 14, wherein the plurality of lenses have the same lens configuration and are arranged at the same positions relative to the corresponding light emitting elements.

16. The line head of claim 1, comprising an aperture diaphragm that is disposed between the lenses and the plurality of light emitting elements, wherein an image side of the lens system is telecentric.

17. An image forming apparatus, comprising:
a latent image carrier;
a line head that exposes a surface of the latent image carrier with light beams to form a latent image; and
a developing unit that develops the latent image with toner,
wherein the line head includes:
a substrate on which a plurality of light emitting elements are provided;
a lens array that includes a plurality of lenses; and
a cover member that is optically transmissive, is provided between the latent image carrier and the lens array, and is provided at the other side of the substrate with respect to the lens array.

18. The image forming apparatus of claim 17, wherein the developing unit develops with the toner which is charged.

19. The image forming apparatus of claim 17, wherein a surface of the lens array that is opposed to the latent image carrier surface is in a substantially concavo-convex shape.

20. An image forming method, comprising:
exposing a latent image carrier surface with light beams using a line head to form a latent image; and
developing the latent image with toner,
wherein the line head includes:
a substrate on which a plurality of light emitting elements are provided;
a lens array that includes a plurality of lenses; and
a cover member that is optically transmissive, is provided between the latent image carrier and the lens array, and is provided at the other side of the substrate with respect to the lens array.
